(19) United States
(12) Patent Application Publication
(10) Pub. No.: US 2006/0194132 A1
(43) Pub. Date: Aug. 31, 2006

(54) Electrophotographic photosensitive member

(75) Inventors: Kazuto Hosoi, Mishima-shi (JP); Satoshi Kojima, Mishima-shi (JP); Jun Ohira, Sunto-gun (JP); Makoto Aoki, Yokohama-shi (JP); Motoya Yamada, Numazu-shi (JP); Hironori Owaki, Susono-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/403,897

(22) Filed: Apr. 14, 2006

Related U.S. Application Data
(63) Continuation of application No. PCT/JP05/23094, filed on Dec. 9, 2005.

(30) Foreign Application Priority Data
Dec. 10, 2004 (JP) 2004-358099
Dec. 10, 2004 (JP) 2004-358131

(51) Int. Cl. G03G 5/147

(52) U.S. Cl. 430/56; 430/66

(57) ABSTRACT

An electrophotographic photosensitive member is provided in which electrophotographic properties including resolving power have been improved with minimized absorption of image exposure light at a short wavelength in a surface layer. The electrophotographic photosensitive member includes a photoconductive layer composed of a non-single-crystal silicon film and a surface region layer composed of a non-single-crystal silicon nitride film containing silicon atoms and nitrogen atoms, superimposed on a conductive substrate. The surface region layer has a gradient-composition layer in which the composition ratio between silicon atoms and nitrogen atoms is changed and a surface layer in which the composition ratio between them is constant. The gradient-composition layer and surface region layer contain a Group 13 element, and the content distribution of the element in the thickness direction of each layer has at least one local maximum value.

This application is a continuation of International Application No. PCT/JP2005/023094 filed on Dec. 9, 2005, which claims the benefit of Japanese Patent Application Nos. 2004-358099 filed on Dec. 10, 2004 and 2004-358131 filed on Dec. 10, 2004.

### BACKGROUND OF THE INVENTION

1. Field of the Invention

The present invention relates to an electrophotographic photosensitive member. In particular, the present invention relates to an electrophotographic photosensitive member optimum for a printer, a facsimile, a copying machine, or the like using light having a relatively short wavelength of 380 nm or more and 500 nm or less for exposure.

2. Related Background Art

In the field of image formation, a photoconductive material in a photosensitive member is requested to have properties including the following properties:
1. Having high sensitivity and a high SN ratio (photo current (Ip)/dark current (Id));
2. Having an absorption spectrum suited for the spectral characteristics of an electromagnetic wave to be applied;
3. Having high photoresponsiveness and a desired dark resistance value; and
4. Being harmless to a human body at the time of use.

In particular, it is important for an electrophotographic photosensitive member to be incorporated into an electrophotographic device to be used as a business machine in an office to be pollution-free at the time of use.

Amorphous silicon (hereinafter, abbreviated as a-Si) is a photoconductive material exhibiting excellent properties satisfying the above-described properties, and has been attracting attention as a photoreceptive member of an electrophotographic photosensitive member.

A photosensitive member having a photoconductive layer composed of a-Si is generally formed on a conductive substrate heated to 50° C. to 350° C. by a film forming method such as a vacuum. deposition method, a sputtering method, an ion plating method, a thermal CVD method, a photo CVD method, or a plasma CVD method. Of those methods, a plasma CVD method has been suitably put into practical use, involving: decomposing a raw material gas by means of a high-frequency wave or through microwave glow discharge,; and forming an a-Si deposition film on a substrate.

For example, Japanese Patent Application Laid-Open No. H07-306539 discloses a technique involving: constituting the surface layer of an a-Si-based photosensitive member of a-Si containing at least one of nitrogen, carbon, and oxygen; and continuously increasing the content of at least one of them in a-Si toward the outermost surface.

In addition, Japanese Patent Application Laid-Open No. 2004-133399 discloses a technique in which the content of a Group 13 element in the periodic table (hereinafter also referred to simply as a “Group 13 element”) in an amorphous layer region superimposed on a photoconductive layer and including silicon as a base material is so distributed as to have at least two local maximum values in the thickness direction of the layer region, for the purpose of preventing a situation in which, despite the fact that no apparent flaw is observed on the surface of a photosensitive member when the surface of the photosensitive member is scratched with a diamond needle having a tip diameter of 0.8 mm with a load applied thereto, an ability to hold a dark potential at the scratched portion is significantly lowered to cause a flaw referred to as a pressure mar causative of an image defect on an image.

However, even when an image is outputted by means of the above-described electrophotographic photosensitive member having a surface layer superimposed on a photoconductive layer, interference occurs in the formation of an electrostatic latent image through image exposure to lower image quality in some cases. To alleviate the drawback, Japanese Patent Application Laid-Open No. H06-242624 discloses a technique for preventing interference involving continuously changing composition from a photoconductive layer toward a surface layer upon formation of the photoconductive layer and the surface layer by means of plasma CVD to prevent a definite reflection surface from being formed.

With those techniques, the electrical, optical, and photoconductive properties of an electrophotographic photosensitive member and the service environment properties of the member have been improved, and image quality has been also improved in association with the improvements.

In addition, in order to satisfy the recent request for an increase in image quality, there has been a growing demand on an increase in definition of an electrostatic latent image as well as a reduction in particle size of toner. One possible method for satisfying the demand in, for example, a digital copying system is a method involving reducing a spot diameter of laser to be used for image exposure. To this end, a reduction in wavelength of laser has been requested.

For example, Japanese Patent Application Laid-Open No. 2000-258938 discloses a technique involving exposing a photosensitive layer formed of a-Si with an ultraviolet violaceous laser beam oscillator having a predominant oscillation wavelength at 380 nm to 450 nm in place of laser light having an oscillation wavelength of 600 to 800 nm having been conventionally and generally used in image exposure.

### SUMMARY OF THE INVENTION

The properties of a conventional a-Si-based electrophotographic photosensitive member such as electrical properties, optical properties, and photoconductive properties (such as a dark resistance value, photosensitivity, and photo-responsiveness), service environment properties, stability with time, and durability have been improved. However, in the present circumstances, in the conventional a-Si-based electrophotographic photosensitive member there is plenty of room for improvement in order to achieve the comprehensive improvements of the properties.

In particular, in recent years, digitalization and colorization have been rapidly promoted. As a result, there has been a growing demand for an increase in image quality of an electrophotographic device (such as high resolution, high definition, the absence of density unevenness, or the absence of image defects (for example, a void or a black spot)).

A reduction in spot diameter of laser light for image formation is effective in increasing the resolution of an image. Examples of a method of reducing the spot diameter of laser light include an increase in accuracy of an optical system for irradiating a photoconductive layer with laser light and an increase in opening ratio of an imaging lens. However, the spot diameter can be reduced only up to a diffraction limit determined by the wavelength of laser light and the opening ratio of the imaging lens. Therefore, for reducing a spot diameter with the wavelength of laser light kept constant, an increase in size of a lens, an improvement in machine accuracy, or the like must be performed, and increases in size and cost of an apparatus have been hardly avoided.

In view of the foregoing, in recent years, a technique for increasing the resolution of an electrostatic latent image in which the wavelength of laser light is shortened to reduce the spot diameter has been attracting attention, based on the fact that the lower limit of the spot diameter of laser light is in direct proportion to the wavelength of the laser light.

In a conventional electrophotographic device, laser light having an oscillation wavelength of 600 to 800 nm is generally used in image exposure. By shortening the wavelength, the resolution of an image can be increased. In recent years, a semiconductor laser having a short oscillation wavelength has been rapidly developed, and a semiconductor laser having an oscillation wavelength at around 400 nm has been put into practical use.

in order for the resolution of an image to be increased by means of any one of such approaches, the material and layer constitution of, in particular, a surface layer of a photosensitive member have been requested to be further improved so that light in such a short wavelength range can be applied to the photosensitive member. That is, a photosensitive layer must have sufficient sensitivity with respect to an image exposure light wavelength. In addition, nearly no light to which the surface layer is exposed should be absorbed. Furthermore, the interference of laser light in a short wavelength range due to the reflection surface between a photoconductive layer and the surface layer should be minimized.

For example, an a-Si-based photosensitive layer has the peak sensitivity at around 600 to 700 nm. The photosensitive layer can have sensitivity even at around 400 to 410 nm under devised conditions although the sensitivity is inferior to the peak sensitivity. Therefore, for example, the photosensitive layer can be used even when laser having a wavelength as short as 405 nm is applied. However, the sensitivity at around 400 to 410 nm may be about half the peak sensitivity, so it is preferable that nearly no absorption of light be present in the surface region of a photosensitive member.

The inventors of the present invention have made studies on an electrophotographic photosensitive member using amorphous silicon nitride (hereinafter referred to as a-SiN) as a surface layer. As a result, and have found that an absorption coefficient of light of around 400 to 410 nm can be reduced by optimizing a condition. However, general improvements in the properties of a photosensitive member enhancing image quality more than ever have been requested to satisfy a recent demand for an increase in image quality, of a digital full-color copying machine. Specifically, the improvement of dot reproducibility more than ever has been requested. At the same time, how a surface layer should be improved so as to be capable of maintaining desired properties is important.

As described above, a material for a surface layer absorbing nearly no light having a short. wavelength around 400 to 410 nm and capable of providing high resolution without impairing electrophotographic properties has been demanded. Furthermore, an electrophotographic photosensitive member including a highly stable surface layer has been strongly demanded.

That is, a first requirement is that nearly no exposure light having a short wavelength around 400 to 410 nm is absorbed in a surface region. A second requirement is that a sufficient function of blocking the injection of negative charges from the surface is exerted. A third requirement is that high resolution capable of taking advantages of a small spot diameter and toner having a small particle size is provided.

The inventors of the present invention have made extensive studies to realize a copying process which solves the above problems, which can be suitably used for a high-image-quality, high-durability and high-speed copying process, which has practically sufficient sensitivity with respect to exposure light of a short wavelength, and which has high chargeability and high contrast. As a result, they have found that the above object can be favorably achieved by: adopting a silicon nitride-based material as a surface layer; and controlling the distribution of the content of a Group 13 element in the periodic table (hereinafter also referred to simply as the “Group 13 element content”) in a surface region layer while minimizing interference due to reflections from a photoconductive layer and the surface layer, thereby achieving the present invention.

In other words, the present invention provides an electrophotographic photosensitive member including: a conductive substrate; a photoconductive layer superimposed on the conductive substrate, composed of a non-single-crystal silicon film using at least silicon atoms as a base material; and a surface region layer superimposed on the photoconductive layer, composed of a non-single-crystal silicon nitride film which uses silicon atoms and nitrogen atoms as base materials and at least part of which contains a Group 13 element in the periodic table, in which the content of the Group 13 element in the periodic table with respect to the total amount of constituent atoms has distribution having at least two local maximum values in the thickness direction of the surface region layer.

Further, the present invention provides an electrophotographic photosensitive member including: a conductive substrate; a photoconductive layer superimposed on the substrate, composed of a non-single-crystal silicon film using at least silicon atoms as a base material; and a surface region layer superimposed on the photoconductive layer, composed of a non-single-crystal silicon nitride film which uses silicon atoms and nitrogen atoms as base materials and at least part of which contains a Group 13 element in the periodic table, the surface region layer having a gradient-composition layer (or a change layer) in which the composition ratio between silicon atoms and nitrogen atoms is changed and a surface layer in which the composition ratio between silicon atoms and nitrogen atoms is constant, wherein the content of the Group 13 element in the periodic table with respect to the total amount of constituent atoms has distribution with at least one local maximum value in the thickness direction of the gradient-composition layer and has distribution with at least one local maximum value in the thickness direction of the surface layer.

According to the present invention having the above constitution, an electrophotographic photosensitive member capable of improving electrophotographic properties can be provided including resolving power while minimizing the absorption of image exposure light at a short wavelength in a surface layer.

### BRIEF DESCRIPTION OF THE DRAWINGS

FIGS. 1A, 1B, and 1C are schematic sectional views each showing an example of an electrophotographic photosensitive member of the present invention.

FIG. 2 is a view schematically showing an example of a suitable constitution of a plasma CVD deposition apparatus using a high-frequency wave in an RF band that can be used for producing the electrophotographic photosensitive member of the present invention.

FIG. 3 is a schematic view showing an example of the constitution of a color electrophotographic device in the present invention.

FIG. 4 shows an example of a depth profile for explaining the local maximum values of the contents of a Group 13 element in the periodic table (boron atoms), oxygen atoms, and fluorine atoms in a surface region layer in the present invention.

FIG. 5 is a graph showing an example of measurements of spectral sensitivity characteristics of an electrophotographic photosensitive member.

FIG. 6 is a graph showing measurements of the correlation between a nitrogen atom concentration in the surface layer of an electrophotographic photosensitive member produced in Example 1 and sensitivity with respect to light having a wavelength of 405 nm.

FIG. 7 is a distribution chart of the content of a Group 13 element in the periodic table with respect to a thickness direction on a photoconductive layer of an a-Si-based photosensitive member of the present invention.

FIG. 8 is a view showing the content distributions of a Group 13 element in the periodic table and a nitrogen atom in the thickness direction of the surface region layer of an example of the electrophotographic photosensitive member of the present invention.

FIG. 9A is a view showing the content distributions of a Group 13 element in the periodic table and nitrogen atoms in the thickness direction of the surface region layer of an example of the electrophotographic photosensitive member of the present invention.

FIG. 9B is a view showing the content distributions of a Group 13 element in the periodic table and nitrogen atoms in the thickness direction of the surface region layer of an example of the electrophotographic photosensitive member of the present invention.

FIG. 10 is a view showing the content distributions of a Group 13 element in the periodic table and nitrogen atoms in the thickness direction of the surface region layer of an example of the electrophotographic photosensitive member of the present invention.

FIG. 11A is a view showing the content distributions of a Group 13 element in the periodic table and nitrogen atoms in the thickness direction of the surface region layer of an example of the electrophotographic photosensitive member of the present invention.

FIG. 11B is a view showing the content distributions of a Group 13 element in the periodic table and a nitrogen atom in the thickness direction of the surface region layer of another example of the electrophotographic photosensitive member of the present invention.

FIG. 12 is a view showing the content distributions of a Group 13 element in the periodic table and a nitrogen atom in the thickness direction of the surface region layer of an example of the electrophotographic photosensitive member of the present invention.

FIG. 13 is a view showing the content distributions of a Group 13 element in the periodic table and nitrogen atoms in the thickness direction of the surface region layer of an example of the electrophotographic photosensitive member of the present invention.

FIGS. 14A, 14B, 14C, and 14D are views each showing the distance between a local maximum value on a photoconductive layer side out of two adjacent local maximum values of a nitrogen atom content in the thickness direction of a surface region layer of an example of an electrophotographic photosensitive member of the present invention and the minimum value present between the two local maximum values.

FIG. 14E is a view showing the content distribution of nitrogen atoms in the thickness direction of the surface region layer of an example of a conventional electrophotographic photosensitive member.

FIG. 15A is a view showing the content distributions of a Group 13 element in the periodic table in the thickness direction of the surface region layer of an example of the electrophotographic photosensitive member of the present invention.

FIG. 15B is a view showing the content distributions of a Group 13 element in the periodic table in the thickness direction of the surface region layer of an example of the electrophotographic photosensitive member of the present invention.

FIGS. 16A and 16B are views each showing a content of a Group 13 element in the periodic table and nitrogen atoms in the thickness direction of the surface region layer of an example of the electrophotographic photosensitive member of the present invention.

FIG. 16C is a view showing the content distributions of a Group 13 element in the periodic table and nitrogen atoms in the thickness direction of the surface region layer of an example of a conventional electrophotographic photosensitive member; and

FIGS. 17A and 17B are views showing the spectral reflection spectrum of the electrophotographic photosensitive member of the present invention.

### DESCRIPTION OF THE PREFERRED EMBODIMENTS

The inventors of the present invention have produced a thin film of an a-SiN-based material suitable as a surface layer. They have found that the absorption of light having a short wavelength of, for example, 400 to 410 nm can be suppressed depending on conditions under which the thin film is produced, and that a photosensitive member having such surface layer has sufficient sensitivity with respect to light having a wavelength around 400 to 410 nm. Specifically, a film reduced in absorption can be obtained by optimizing, for example, kinds and flow rates of raw material gases, the ratio between the gases, and a ratio of applied electric power to the gas amount.

Upon analyzing the film produced under such conditions by X-ray photoelectron spectroscopy (XPS), Rutherford backscattering spectrometry (RBS), secondary-ion mass spectrometry (SIMS) or the like, it has been revealed that where an average nitrogen concentration is represented by N/(Si+N), the nitrogen content range in which absorption in a practical thickness is acceptable preferably satisfies the relationship of 30 atm %≦N/(Si+N).

It has been also found that the relationship of N/(Si+N)≦70 atm % is preferably satisfied in view of the yield of the film. When N/(Si+N) is 70 atm % or less, unevenness such as thickness unevenness, hardness unevenness, or resistance unevenness hardly occurs. Furthermore, the strength of the film can be maintained and the film can be produced stably in a high yield. As a result, the film has preferable properties to be used as a surface layer. However, when N/(Si+N) exceeds 70 atm %, unevenness such as thickness unevenness, hardness unevenness or resistance unevenness is apt to occur and the yield may be significantly reduced. This is probably because an excessively large amount of nitrogen extremely destabilizes bonds of the film. Furthermore, it has been found that the strength of the film can be maintained and the film can be preferably used as a surface layer when N/(Si+N) is in the range of 70 atm % or less.

As described above, an a-SiN-based film reduced in absorption of light having a short wavelength can be obtained by optimizing production conditions. However, such film itself has a high volume resistance, so a residual potential may be large. The large residual potential may be a factor of inhibiting the achievement of high image quality suitable for full-color. Furthermore, the interference due to reflections from a photoconductive layer and a surface layer should be minimized.

It has been found that when the content of a Group 13 element in the periodic table has distribution having at least one local maximum value in the thickness direction of a surface layer, the following effects are exhibited:
1. A residual potential can be reduced and an additional improvement of image quality can be achieved;
2. Electrophotographic properties including improved chargeability and suppressed optical memory can be obtained; and
3. An ability to block the injection of charges from the outermost surface increases, so chargeability additionally increases.

Although the reason why those effects can be exhibited has not been revealed, the present inventors consider that adding an Group 13 element in the periodic table causes the alleviation of bonds in an a-SiN film originally having a large stress, and, as a result, the number of defects decreases to improve the travelling property of carriers and to reduce a residual potential.

When the number of defects of a surface layer decreases to thereby reduce a residual potential, the number of shallow traps present in the film is reduced. As a result, for example, carriers trapped after charging are prevented from being excited again not to come out by the time of development. Such carriers coming out of a shallow trap is originally expected to drift so as to compensate for a potential difference resulting from the formation of a latent image. Therefore, such carriers are expected to make the latent image null or reduce the depth of the latent image. Accordingly, it is considered that if the number of traps decreases, causes for making a latent image null are reduced, resulting in increased resolution.

In addition, arranging a gradient-composition layer in which the composition ratio between silicon atoms and nitrogen atoms is continuously changed is effective in minimizing interference due to reflections from a photoconductive layer and a surface layer. Specifically, the gradient-composition layer is preferably arranged in such a manner that the minimum value (Min) and maximum value (Max) of a reflectivity (%) in the wavelength range of 350 nm to 680 nm satisfy the relationship of 0%≦Max(%)≦20% and the relationship of 0≦(Max−Min)/(100−Max)≦0.15. The term “reflectivity” as used herein refers to the value of a reflectivity (percentage) measured by means of a spectrophotometer (MCPD-2000, manufactured by Otsuka Electronics Co., Ltd.). Specifically, the spectral emission intensity I(o) of the light source of a spectroscope is measured, the spectral reflected light intensity I(D) of a photosensitive member is measured, and a reflectivity R=I(D)/I(o) is determined.

When minimizing the interference due to reflections from a photoconductive layer and a surface layer as in the present invention, the image density unevenness due to the abrasion of the surface layer is, prevented from occurring.

Furthermore, the inventors of the present invention have variously reviewed conditions under which a surface region layer is formed while paying attention to chargeability and image defects. As a result, they have found that when providing a nitrogen atom content with respect to the total amount of constituent atoms in the surface region layer with at least two local maximum values in the thickness direction of the layer, chargeability can be improved while controlling the absorption coefficient of the surface region layer with respect to light having a wavelength of 500 nm or less to be small, thereby suppressing image defects. It has been found that this effect is more significant when two local maximum values of the nitrogen atom content and two local maximum values of the content of a Group 13 element in the periodic table are alternately arranged in the thickness direction of the layer or when a local maximum value of the content of the Group 13 element in the periodic table and a local maximum value of the nitrogen atom content are arranged in the stated order from the photoconductive layer side toward the free surface. This is probably because reducing the nitrogen. concentration of a region to which the Group 13 element in the periodic table is added improves charge controllability and additionally improves an ability to block the injection of charges from the outermost surface. In addition, image defects are suppressed probably because an ability to block charge injection is improved and an ability to block charges escaping to the substrate side through the interface between a projection and a normally deposited portion of a deposition film. In addition, effects such as an improvement in chargeability and the suppression of image defects can be exhibited when the distance between a local maximum value on the photoconductive layer side out of two adjacent local maximum values of the nitrogen atom content with respect to the total number of constituent atoms in the thickness direction and the minimum value between the two local maximum values is 40 nm or more, and sufficient sensitivity with respect to exposure light of a short wavelength can be obtained when that distance is in the range of 300 nm or less.

Furthermore, the inventors of the present invention have variously reviewed conditions under which a surface layer is formed while paying attention to the film structure of a-SiN. As a result, they have found that cleaning properties can be improved by adding oxygen atoms and/or fluorine atoms.

An a-SiN film is apt to relatively to exhibit a columnar structure depending on production conditions. In a state in which the number of columnar structures is large, the number of structural boundaries appearing on a surface is expected to be large. A transfer residue or a cleaning residue is apt to generate in such a state. Adding oxygen atoms and/or fluorine atoms reduces a transfer residue or a cleaning residue probably because the number of defects decreases as described above to reduce the number of columnar structures, and the number of structural boundaries appearing on a surface are reduced.

Furthermore, the inventors have made studies on the addition of oxygen atoms and/or fluorine atoms. As a result, they have found that when such kinds of atoms are incorporated to provide local maximum values of their contents in the surface layer, none of the detrimental effects such as a reduction in hardness and an increase in residual potential are caused, and cleaning properties for a transfer residue and a cleaning residue are effectively improved. It has been also found that while the effect can be obtained even when either oxygen atoms or fluorine atoms are added to provide the local maximum value in the surface layer, it is more preferable that both oxygen atoms and fluorine atoms are added to provide the local maximum value.

Next, embodiments of the present invention will be described in detail with reference to the drawings.

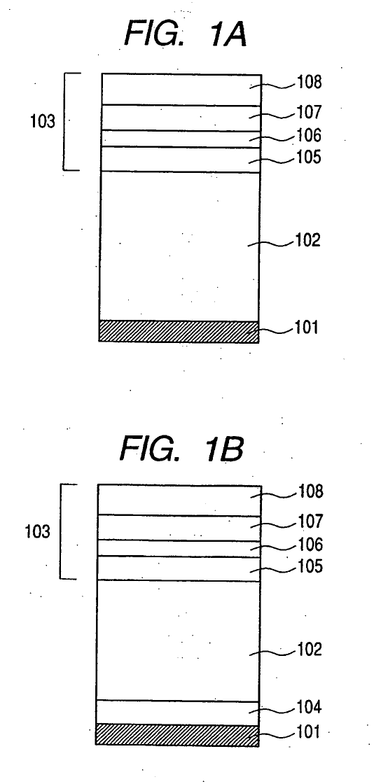

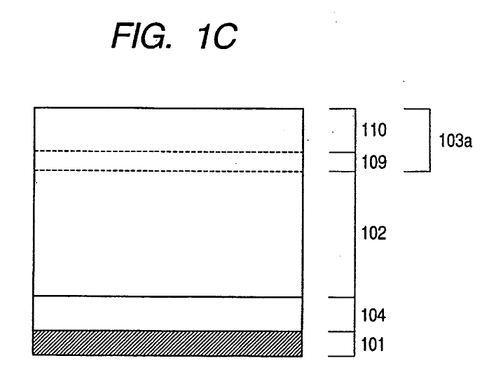

FIGS. 1A, 1B, and 1C are schematic views each showing the layer constitution of an electrophotographic photosensitive member in the present invention.

An electrophotographic photosensitive member shown in FIG. 1A has a photoconductive layer 102 and a surface region layer 103 in this order formed on a conductive substrate 101. An electrophotographic photosensitive member shown in FIG. 1B has a lower injection-blocking layer 104, the photoconductive layer 102, and the surface region layer 103 in this order formed on the conductive substrate 101. An electrophotographic photosensitive member shown in FIG. 1C has the lower injection-blocking layer 104, the photoconductive layer 102, and a surface region layer 103 a composed of a gradient-composition layer 109 and a surface layer 110, in this order formed on the conductive substrate 101.

The lower injection-blocking layer 104, the photoconductive layer 102, and the surface region layer 103 formed on the conductive substrate 101 are referred to as a photosensitive layer.

It is preferable that the lower injection-blocking layer 104 is arranged for blocking the injection of charges from the side of the conductive substrate, although the layer is not necessarily needed.

The surface region layer 103 has a first upper injection-blocking layer 105 (TBL-1), an intermediate layer 106, a second upper injection-blocking layer 107 (TBL-2), and a surface-protective layer (SL) 108 formed in the stated order.

The gradient-composition layer 109 is preferably arranged on the side of the photoconductive layer 102 in such a manner that a change in refractive index becomes continuous between the surface region layer 103a and the photoconductive layer 102.

When there is the difference in refractive index between the surface layer 110 and the photoconductive layer 102, interference occurs at a layer interface, and a fluctuation in sensitivity due to abrasion is apt to occur, and remarkable image density unevenness appears owing to slight abrasion unevenness. To prevent this, the composition of the surface layer 109 gently varies to gradually change the refractive index, and the surface layer 110 and the photoconductive layer 102 are connected with the difference in refractive index between them made gradual. As a result, the reflection of light at a layer interface resulting from the difference in refractive index between the surface region layer 103a and the photoconductive layer 102 is suppressed, and interference at an interface in the case where coherent light is used for exposure is prevented.

Here, each of the foregoing layers will be described in detail.

<Surface Region Layer>

Each of the surface region layers 103 and 103a in the present invention is arranged for providing good properties mainly concerning transmittance of light having a short wavelength, high resolution, resistance to continuous repeated use, moisture resistance, resistance to service environments, electrical properties, and the like. In the case of an electrophotographic photosensitive member for positive charging, each of the surface region layers serves also as a charge holding layer. In the case of an electrophotographic photosensitive member for negative charging as well, each of the surface region layers may serve as a charge holding layer, but a gradient-composition layer to be described later is preferably provided with a function of holding charge in terms of degree of freedom of design of the surface layer.

The surface region layer 103a in the present invention has the surface layer 110 and the gradient-composition layer 109, and a material for the layer 103a is composed of a non-single-crystal material which uses silicon atoms and nitrogen atoms as base materials and at least part of which contains an Group 13 element in the periodic table. The layer 103a preferably contains hydrogen atoms, oxygen atoms, and/or fluorine atoms in an appropriate manner. In this case, the amount of nitrogen in the surface layer 110 is preferably in the range of 30 atm % to 70 atm % with respect to the sum of silicon atoms and nitrogen atoms.

In the surface region layer 103a of the present invention, it is important for the Group 13 element content to provide distribution having at least one local maximum value in the thickness direction of each of the gradient-composition layer 109 and the surface layer 110.

Here, it is preferable that a local maximum value in the gradient-composition layer closest to the photoconductive layer out of the local maximum values of the Group 13 element content is highest, for improving electrical properties.

Further, the distance between two adjacent local maximum values of the Group 13 element content is preferably in the range of 100 nm to 1,000 nm in the thickness direction of the film for improving electrical properties such as chargeability and resolution such as dot reproducibility.

It is also preferable to distribute the Group 13 element in such a manner that: a local maximum value of the Group 13 element content closest to the photoconductive layer is 5.0×10¹⁸ atoms/cm³ or more; or the minimum value present between two adjacent local maximum values is 2.5×10¹⁸ atoms/cm³ or less for improving electrical properties such as chargeability and resolution such as dot reproducibility.

FIG. 4 is a schematic concentration profile of each element in the surface region layer.

As shown in FIG. 4, in the surface region layer, a local maximum value of each of the boron atom (an atom belonging to Group 13 in the periodic table) content, the carbon atom content, the fluorine atom content and the oxygen atom content are formed on the outermost surface side, and another local maximum value of the boron atom content is formed at a deeper position close to the photoconductive layer. In other words, the local maximum value of each of the carbon atom content, the fluorine atom content and the oxygen atom content is observed at one position, and the local maximum value of the boron atom content are observed at two positions.

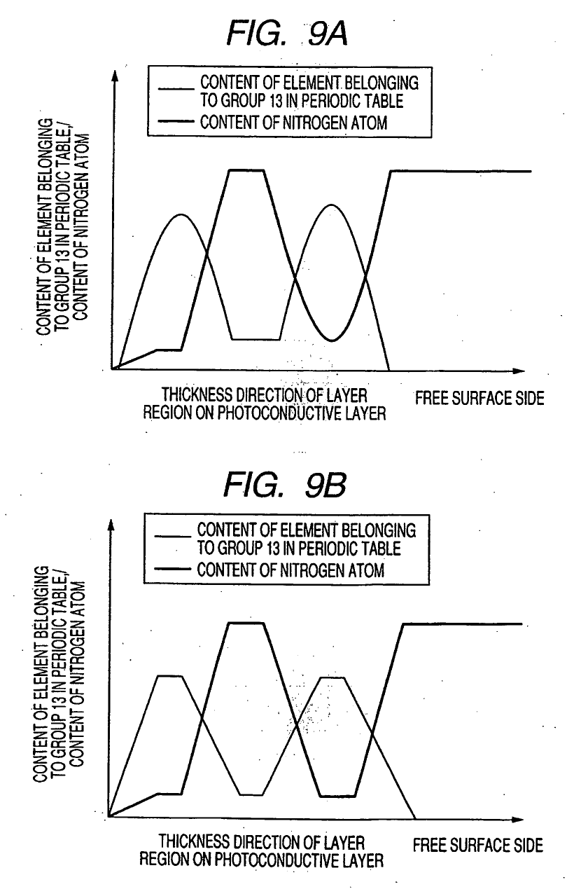

In addition to the local maximum value of the Group 13 element content in the surface region layer 103, 103a, it is preferable that the nitrogen atom content includes at least two local maximum values. The number of local maximum values of each of the Group 13 element content and the nitrogen atom content in the surface region layer in the thickness direction may be at least two. The number of local maximum values of each of the contents may be two or three. Alternatively, the numbers of local maximum values of the contents may be different from each other. For example; the number of local maximum values may be two for one of the contents, and three or four for the other. Those local maximum values may be placed at any positions in the thickness direction of the surface region layer. For example, as shown in the graph of FIG. 8 showing the content of a Group 13 element in the periodic table and a nitrogen atom content, the local maximum values of the respective atom contents may be placed at an identical position in the thickness direction. As shown in the graphs of FIGS. 9A, 9B, 10, 11A, 11B, 12 and 13 each showing the nitrogen atom content and the content of the Group 13 element in the periodic table, the local maximum values of the respective atom contents are preferably alternately placed. In this case, the content of the Group 13 element in the periodic table preferably has a local maximum value on the photoconductive layer side because the chargeability of the photosensitive member can be increased. In addition, it is particularly preferable that the nitrogen atom content has a local maximum value on the free surface side, in terms of the flaw resistance and wear resistance of the photosensitive member. A surface region layer having such a local maximum value can have a layer constitution in which two or more upper injection-blocking layers each having one, local maximum value of the Group 13 element content in a thickness direction, for example, a first upper injection-blocking layer 105 and a second upper injection-blocking layer 107, and one or two or more intermediate layers 106 each having one local maximum value of the nitrogen atom content in the thickness direction are alternately arranged on a photoconductive layer and a surface protective layer 108 having one local maximum value of the nitrogen atom content in the thickness direction is arranged as an outermost layer having a free surface.

In the present invention, a local maximum value of the Group 13 element content in the thickness direction of the film can be generated by controlling the supply of the Group 13 element during the formation of the surface region layer 103. The supply of the Group 13 element can be controlled by appropriately changing growth conditions such as the flow rate and concentration of a gas for supplying the Group 13 element, the flow rate of a gas for supplying silicon/nitrogen atoms as base materials, and growth temperature.

Specific examples of the Group 13 element include boron (B), aluminum (Al), gallium (Ga), indium (In), and thallium (Ta). Of those, boron is particularly suitable. Specific examples of a gas for supplying the Group 13 element include: boron hydrides such as B₂H₆, B₄H₁₀, B₅H₉, B₅H₁₁, B₆H₁₀, B₆H₁₂, and B₆H₁₄; boron halides such as BF₃, BCl₃, and BBr₃; AlCl₃; GaCl₃; Ga(CH₃)₃; InCl₃; and TlCl₃.

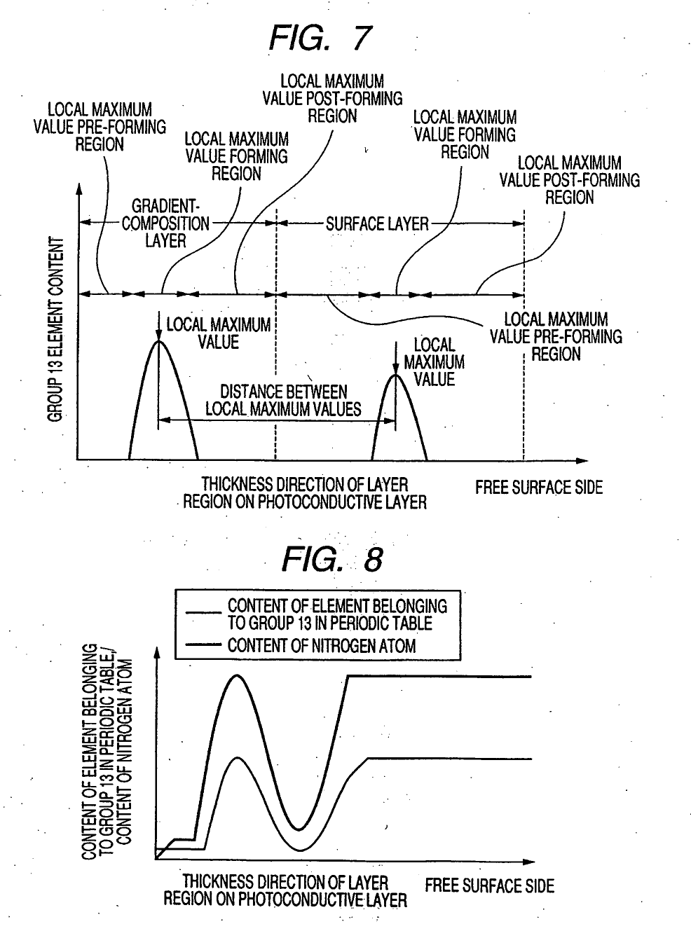

Here, an example of the above local maximum value in the present invention will be described with reference to FIG. 7.

FIG. 7 schematically shows an example of a state in which the distribution of the Group 13 element in the periodic table has a local maximum value at one position of each of the gradient-composition layer and surface layer of a surface region layer.

In the present invention, as shown in FIG. 7, a local maximum value of the content of the Group 13 element in the periodic table is desirably present at a peak of the content distribution. Alternatively, the local maximum value may be present with a width in a certain region of the content distribution. In addition, the distance between local maximum values represents a distance shown in FIG. 7.

When a local maximum value of the content is present with a width in a certain region, the center of the certain region is defined as the position of the local maximum value.

As in the case of a local maximum value of the Group 13 element content shown in FIG. 7, a local maximum value of the oxygen atom content and/or the fluorine atom content preferably shows distribution having no width in a certain region. In a film such as an a-SiN film with large stress, distribution in which a local maximum value of a content has no width in a certain region can more easily form a local region for effectively relaxing stress than distribution having a width in a certain region, with the result that the stress relaxation of the entire film is expected to efficiently progress. Accordingly, a local maximum value of a content is preferably controlled so as not to be present with a width in a certain region.

In addition, it is considered that in the distribution in which a local maximum value of a content has no width in a certain region, a region is provided as locally as possible in which carriers causing dot reproducibility or fine-line reproducibility to deteriorate are apt to spread in the movement of photocarriers due to image exposure, whereby the spreading is so suppressed as to be small.

The oxygen atom content or fluorine atom content in the surface layer 110 is in the range of preferably 0.01 atm % to 20 atm %, more preferably 0.1 atm % to 10 atm %, or still more preferably 0.5 atm % to 8 atm % with respect to the total amount of constituent atoms. If adding an oxygen atom- or fluorine atom-containing gas such as NO or SiF₄ diluted with a gas such as H₂, He, Ne or Ar with its flow rate controlled through a massflow controller, it is sufficient for adjusting the content in such range.

Hydrogen atoms are preferably incorporated into the surface layer 110. Hydrogen atoms compensate for the unused bonding valences of silicon atoms to improve the quality of the layer, in particular, the photoconductive properties and charge holding properties of the layer. In ordinary cases, the average hydrogen content in the layer is preferably 5 to 70 atm %, more preferably 8 to 60 atm %, or still more preferably 10 to 50 atm % with respect to the total amount of constituent atoms.

Examples of a substance that can be effectively used as a gas for supplying silicon (Si) used for forming the surface layer 110 include: gaseous substances such as SiH₄, Si₂H₆, Si₃H₈, and Si₄H₁₀; and silicon hydrides (silanes) capable of being gasified. Of those, SiH₄ and Si₂H₆ are preferable from the viewpoint of easiness of handling in the production of the layer, good efficiency of Si supply and the like. Such raw material gas for supplying Si may be diluted with a gas such as H₂, He, Ar or Ne as required.

Examples of a substance that can be effectively used as a gas for supplying nitrogen or oxygen include: gaseous substances such as N₂, NH₃, NO, N₂O, NO₂, O₂, CO, and CO₂; and compounds capable of being gasified. Of those, nitrogen is a preferable gas for supplying nitrogen because best properties can be obtained. NO is a preferable gas for supplying oxygen. Each of those raw material gases for supplying nitrogen and oxygen may be diluted with a gas such as H₂, He, Ar and Ne as required. In particular, in the case where a slight amount of oxygen is added, for example, an NO gas is diluted with an He gas in advance and is supplied, so that the flow rate of the gas can be precisely controlled.

Further, a silicon fluoride such as SiF₄ or Si₂F₆, or a fluorine gas (F₂), an interhalogen compound such as BrF, ClF, ClF₃, BrF₃, BrF₅, IF₃ or IF₇, may be introduced for supplying fluorine atoms.

In addition, a gas for supplying oxygen atoms and fluorine atoms may be a mixture of multiple kinds of the above gases. In particular, NO or a mixed gas containing NO and appropriately diluted with a diluent gas such as He is most preferable for supplying oxygen atoms. In addition, SiF4 is the most preferable example of a gas for supplying fluorine atoms. The use of those gases provided most preferable results concerning electrophotographic properties when viewed totally.

The gas pressure of a reaction vessel, discharge electric power, and the temperature of the substrate must be appropriately set for forming the surface region layer 103a. In general, the substrate temperature whose optimum range is appropriately selected in accordance with the layer design is in the range of preferably 150° C. to 350° C., more preferably 180° C. to 330° C., or still more preferably 200° C. to 300° C.

In general, the pressure in the reaction vessel whose optimum range is similarly appropriately selected in accordance with the layer design is in the range of preferably 1×10⁻² Pa to 1×10³ Pa, more preferably 5×10⁻² Pa to 5×10² Pa, or still more preferably 1×10⁻¹ Pa to 1×10² Pa.

The thickness of the surface layer 110 is preferably 0.1 to 3 μm, more preferably 0.15 to 2 μm, or still more preferably 0.2 to 1 μm.

When the thickness is larger than 0.01 μm, the layer region on the surface side is not lost owing to abrasion or the like during the use of a light-receiving member. No deterioration in electrophotographic properties such as an increase in residual potential occur as long as the thickness does not exceed 3 μm.

In the present invention, the above-described ranges are exemplified as desirable numerical ranges for the temperature of a conductive substrate and a gas pressure for forming the surface region layer 103a. However, in general, conditions are not determined independently or separately. Optimum values are desirably determined on the basis of mutual and organic relevance for forming a photosensitive member having desired properties.

In the present invention, the composition of the gradient-composition layer 109 is gradually varied to gently change a refractive index, so that the difference in refractive index between the surface layer 110 and the photoconductive layer 102 is made gentle. As a result, the influence of interference due to the reflection of light at the interface between the photoconductive layer 102 and the surface layer 110 can be reduced. Furthermore, when adding a Group 13 element in the periodic table, an effect is exhibited such that the penetration of charges from an upper portion (that is, from the surface layer side) is blocked so that chargeability is improved.

In addition, in the present invention, the gradient-composition layer 109 is preferably arranged in such a manner that the minimum value (Min) and maximum value (Max) of the reflectivity (%) of light having a wavelength of 350 nm to 680 nm at an interface between the photoconductive layer 102 and the surface layer 110 satisfy the relationship of 0%≦Max(%)≦20% and the relationship of 0≦(Max−Min)/(100−Max)≦0.15, and optical continuity can be achieved.

The thickness of the gradient-composition layer is in the range of preferably 5 nm to 1,000 nm, more preferably 10 nm to 800 nm, or still more preferably 15 nm to 500 nm in terms of, for example, desired electrophotographic properties and an economic effect. When the thickness is equal to or larger than 5 nm, a sufficient ability to block the injection of charges from the surface side can be obtained, and sufficient chargeability can be obtained. As a result, no reduction in electrophotographic properties occurs. As long as the thickness is equal to or less than 1,000 nm, the improvement of electrophotographic properties can be expected, and no reduction in properties such as sensitivity occurs.

In general, the pressure in the reaction vessel whose optimum range is similarly appropriately selected in accordance with the layer design is in the range of preferably 1×10⁻² Pa to 1×10³ Pa, more preferably 5×10⁻² Pa to 5×10² Pa, or still more preferably 1×10⁻¹ Pa to 1×10² Pa.

Furthermore, in general, the substrate temperature whose optimum range is appropriately selected in accordance with the layer design is in the range of preferably 150° C. to 350° C., more preferably 180° C. to 330° C., or still more preferably 200° C. to 300° C.

(Upper Injection-Blocking Layer (TBL))

The upper injection-blocking layer to be arranged in the surface region layer in the present invention is composed of a non-single-crystal silicon nitride film using a silicon atom and a nitrogen atom as base materials, and has one local maximum value of the Group 13 element content in its thickness direction. Incorporating the Group 13 element in the periodic table provides a function of blocking the injection of charges from the surface side to the first layer side when the free surface of a photosensitive member is subjected to negative charge treatment. Specific examples of the Group 13 element in the periodic table include boron (B), aluminum (Al), gallium (Ga), indium (In) and thallium (Tl). Of those, boron is particularly suitable in terms of, for example, easiness of handling.

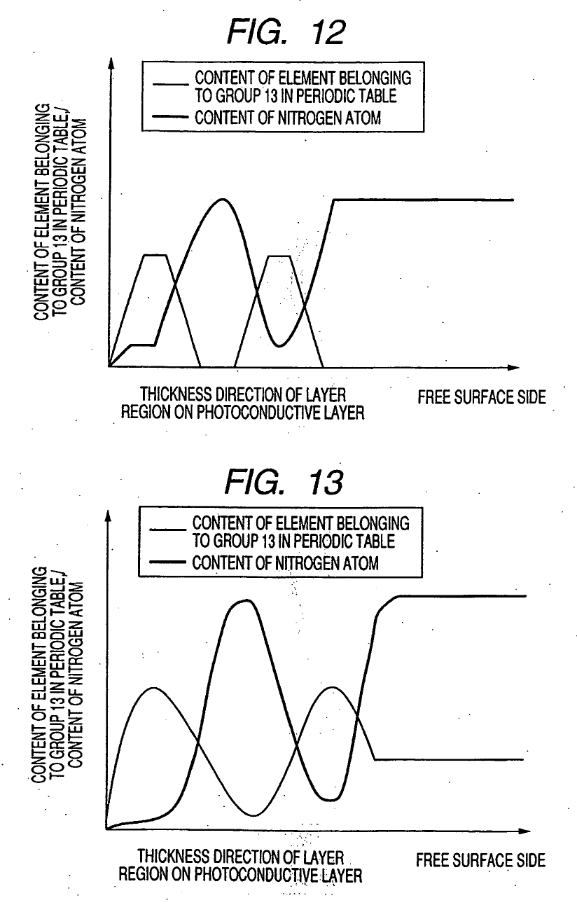

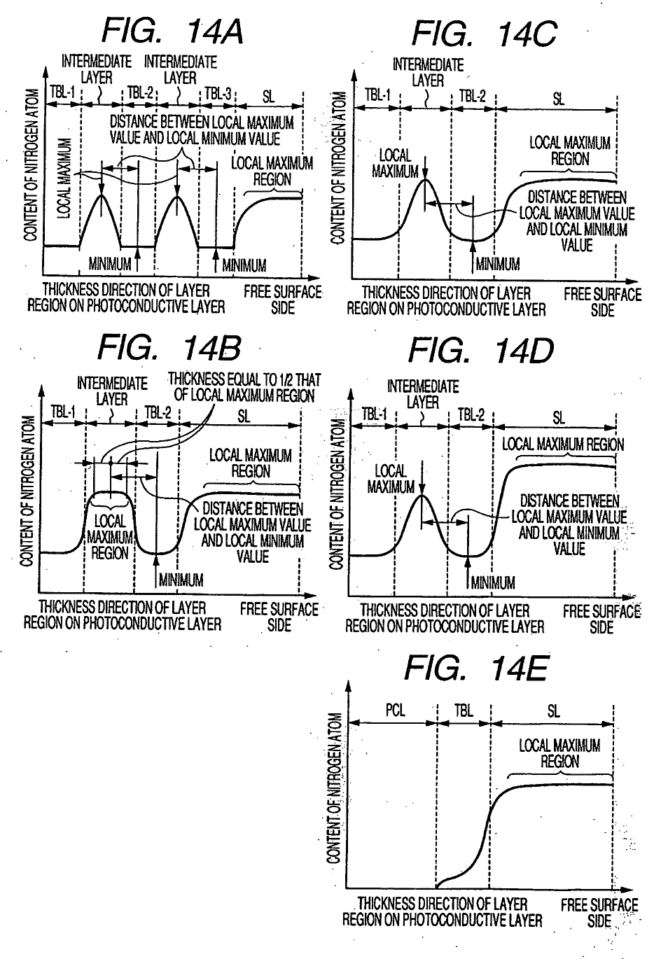

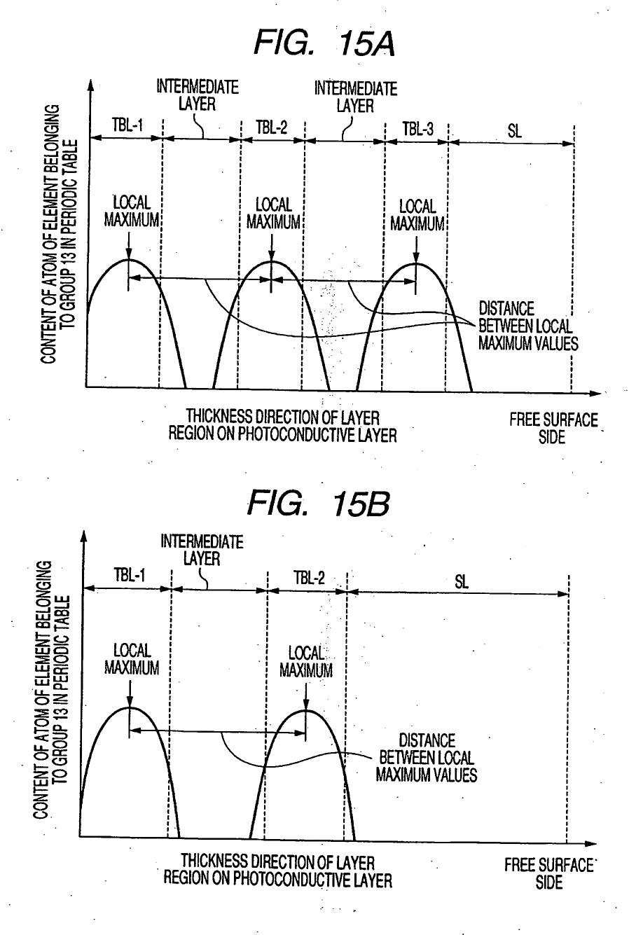

As shown in each of FIGS. 9A, 10, 11A, and 11B, such content distribution may be of a shape having a peak as a local maximum value. Alternatively, as shown in each of FIGS. 9B and 12, the distribution may be of a shape in which a local maximum value is present over a certain length in the thickness direction (referred to as a local maximum region). In this case, as shown in each of FIGS. 14A and 14B, the value at a position corresponding to half of a thickness having a local maximum region is defined as a local maximum value (the same holds true for the following). As shown in FIG. 15B, two upper injection-blocking layers (two of TBL-1, TBL-2 and TBL-3) may be arranged with an intermediate layer interposed therebetween. Alternatively, as shown in FIG. 15A, the three upper injection-blocking layers may be arranged with an intermediate layer interposed between two adjacent layers of them. A local maximum value closest to the free surface out of the local maximum values of the Group 13 element content in the thickness direction each of which is provided for each of the upper injection-blocking layers is preferably highest in terms of sensitivity, electric potential unevenness, optical memory, transmittance and cleaning property. Such a local maximum value is in the range of preferably 50 atm ppm to 3,000 atm ppm, or more preferably 100 atm ppm to 1,500 atm ppm with respect to the total number of the constituent atoms of the upper injection-blocking layer. The Group 13 element content at the highest local maximum value is specifically, for example, 5.0×10¹⁸ atoms/cm³ or more. In relation to the highest value of the Group 13 element content in the thickness direction, the Group 13 element content at the lowest local minimum value in the intermediate layer described later having a low content of the Group 13 element is specifically, for example, 2.5×10¹⁸ atoms/cm³ or less in terms of sensitivity properties. It should be noted that the Group 13 element incorporated with non-uniform distribution having a local maximum value in the thickness direction is preferably evenly incorporated with uniform distribution in a plane parallel to the surface of a substrate for uniformizing properties in an identical plane.

In such local maximum values of the Group 13 element content, the distance between adjacent local maximum values is preferably in the range of 100 nm to 1,000 nm in terms of resolution, chargeability, residual potential and sensitivity in a photosensitive member.

The upper injection-blocking layer may preferably contain oxygen atoms as required. Nitrogen atoms or oxygen atoms to be incorporated into the upper injection-blocking layer may be distributed evenly and uniformly in the layer. Alternatively, the atoms may be distributed non-uniformly in a thickness direction. However, in any case, those atoms must be evenly incorporated with uniform distributions in a plane parallel to the surface of a substrate for uniformizing properties in an identical plane.

The content of nitrogen atoms incorporated into each of the upper injection-blocking layers in the present invention is appropriately determined in such a manner that the object of the present invention is effectively achieved. When no oxygen atom is incorporated, the nitrogen atom content is in the range of preferably 10 atm % to 70 atm %, more preferably 15 atm % to 65 atm %, or still more preferably 20 atm % to 60 atm % with respect to the total number of silicon and nitrogen atoms. When oxygen atoms are incorporated, each of the nitrogen atom content and an oxygen atom content is in the range of preferably 10 atm % to 70 atm %, more preferably 15 atm % to 65 atm %, or still more preferably 20 atm % to 60 atm % with respect to the total number of nitrogen, oxygen, and silicon atoms.

It is preferable to incorporate hydrogen atoms and/or halogen atoms into the upper injection-blocking layer. This is because such atoms bind to unused bonding valences of silicon atoms to improve the quality of the layer, in particular, the photoconductive properties and charge holding properties of the layer. The hydrogen atom content is in the range of, for example, 30 atm % to 70 atm %, preferably 35 atm % to 65 atm %, or more preferably 40 atm % to 60 atm % with respect to the total amount of constituent atoms. In addition, the halogen atom content is in the range of, for.example, 0.01 atm % to 15 atm %, preferably 0.1 atm % to 10 atm %, or more preferably 0.5 atm % to 5 atm %.

The composition. in each of the upper injection-blocking layers 105 and 107 is preferably changed continuously from the photoconductive layer 102 toward the surface protective layer 108 because such change has, for example, an effect of improving adhesiveness and an effect of preventing interference.

The thickness of each of the upper injection-blocking layers can be in the range of, for example, 10 nm to 1,000 nm, and is in the range of preferably 30 nm to 800 nm, or more preferably 50 nm to 500 nm for optimizing the distance between local maximum values of the Group 13 element content in the thickness direction of adjacent upper injection-blocking layers in terms of, for example, desired electrophotographic properties and an economic effect such as efficient production and in relation to the thickness of the intermediate layer to be described later and to the distance between a minimum value between two adjacent local maximum values of the nitrogen atom content in the thickness direction and the local maximum value on the photoconductive layer side. When the thickness is 10 nm or more, sufficient chargeability for blocking the injection of charges from the surface side can be obtained, and good electrophotographic properties can be obtained. In addition, when the thickness is 1,000 nm or less, the improvement of electrophotographic properties can be expected, and good sensitivity properties can be obtained. In addition, the thickness of the second upper injection-blocking layer (TBL-2) 107 is preferably in the range of 10 nm to 300 nm for improving the electric potential properties and sensitivity properties of a photosensitive member.

The upper injection-blocking layer can be formed according to, for example, a plasma CVD method. An example of a method of forming the upper injection-blocking layer according to the plasma CVD method involves supplying a reaction vessel having a conductive substrate installed therein with raw materials gases such as a gas for supplying Si, a gas for supplying N, and a gas for supplying an Group 13 element and, as required, a gas for supplying O to form a deposition film. In this case, a mixing ratio of the raw material gases, a gas pressure in the reaction vessel, discharge electric power and the temperature of the substrate can be appropriately set. The pressure in the reaction vessel whose optimum range is similarly appropriately selected in accordance with layer design is in the range of, for example, 1×10⁻² Pa to 1×10³ Pa, preferably 5×10⁻² Pa to 5×10² Pa, or more preferably 1×10⁻¹ Pa to 1×10² Pa. Furthermore, the temperature of the substrate whose optimum range is appropriately selected in accordance with the layer design is in the range of, for example, 150° C. to 350° C., preferably 180° C. to 330° C., or more preferably 200° C. to 300° C.

The provision of the local maximum value of the Group 13 element content in the thickness direction may be carried out according to a method involving changing the amount of a raw material gas containing the Group 13 element to be introduced.

[Intermediate Layer]

One or two or more intermediate layers arranged in the surface region layer in the present invention are each composed of a non-single-crystal silicon nitride film using silicon atoms and nitrogen atoms as base materials, and each have one local maximum value of the nitrogen atom content in the thickness direction. Such intermediate layer is positioned between the first upper injection-blocking layer (TBL-1) and the second upper injection-blocking layer (TBL-2) or between the second upper injection-blocking layer (TBL-2) and the third upper injection-blocking layer (TBL-3). As a result, the Group 13 element content with respect to the total number of the constituent atoms in the surface region layer has two or more local maximum values in the thickness direction of the surface region layer, and has a local minimum value to be inevitably formed between the two local maximum values. Furthermore, the distribution of the nitrogen atom content is formed having two or more local maximum values in the thickness direction of the surface region layer together with a local maximum value of the nitrogen atom content in the surface protective layer to be described later.

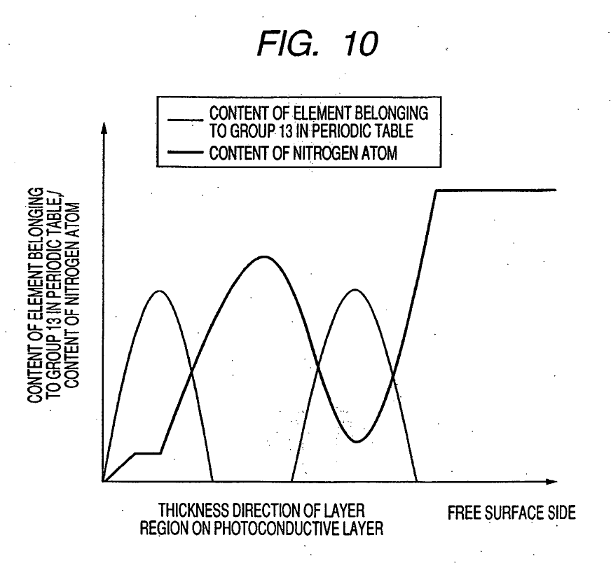

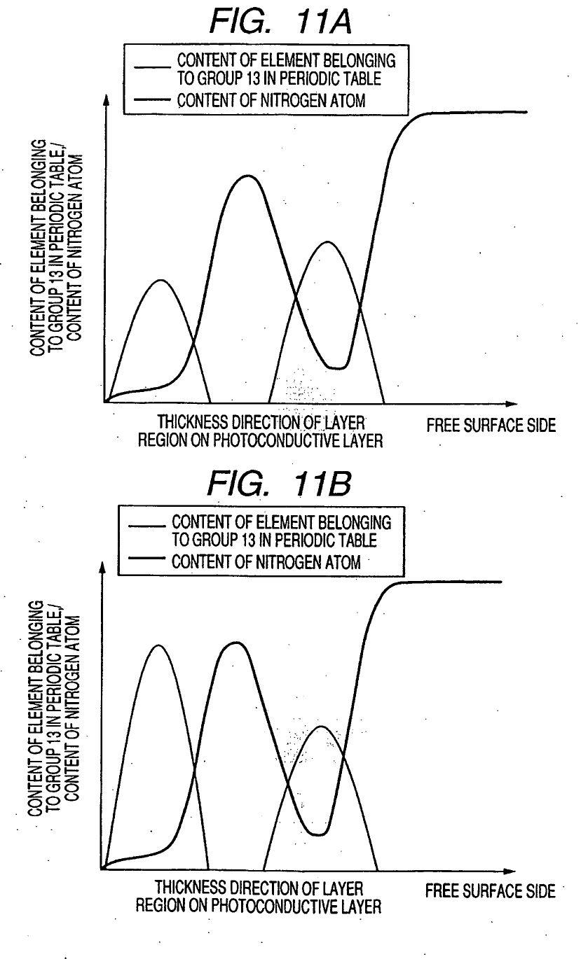

As shown in each of FIGS. 10, 11A and 11B, the distribution of the nitrogen atom content may be of a shape having a peak as a local maximum value. Alternatively, as shown in each of FIGS. 9A and 9B, the distribution may be of a shape having a local maximum region. Such a local maximum value preferably satisfies the relationship of N/(Si+N)≧30 atm % with respect to the total number of the constituent atoms of the intermediate layer. A ratio of a local maximum value of the nitrogen atom content in the thickness direction to the minimum value of the nitrogen atom content in the upper injection-blocking layer having a low nitrogen atom content (local maximum value/minimum value) is preferably 1.10 or more provided that nitrogen atoms to be incorporated with non-uniform distribution having a local maximum value in the thickness direction are preferably evenly incorporated with a uniform distribution in a plane parallel to the surface of a substrate for uniformizing properties in an identical plane.

The distance between the local maximum value of the nitrogen atom content on the photoconductive layer side and the minimum value between that local maximum value and the local maximum value of the nitrogen atom content adjacent thereto is preferably in the range of 40 nm to 300 nm for suppressing image defects.

FIGS. 14A, 14B, 14C, and 14D each schematically show the distance between the local maximum value on the photoconductive layer side out of two adjacent local maximum values of the nitrogen atom content with respect to the total number of the constituent atoms in the, surface region layer in the thickness direction of the layer and the minimum value between the two local maximum values.

Oxygen or a Group 13 element in the periodic table can be incorporated into an intermediate layer as required. Nitrogen atoms or oxygen atoms to be incorporated into each intermediate layer are incorporated into the intermediate layer at an average content in the range of preferably 10 atm % to 90 atm %, more preferably 15 atm % to 85 atm % (both inclusive), or still more preferably 20 atm % to 80 atm % with respect to the total number of the constituent atoms of each intermediate layer in terms of sensitivity properties and electrical properties. Oxygen atoms to be incorporated into the intermediate layer may be distributed evenly and uniformly in the layer. Alternatively, the atoms may be distributed non-uniformly in the thickness direction. However, in any case, those atoms are preferably evenly incorporated with a uniform distribution in a plane parallel to the surface of a substrate for uniformizing properties in the plane.

In addition, the thickness of the intermediate layer 106 is related also to the thickness of the upper injection-blocking layer, and is more preferably selected in such a manner that the distance between adjacent local maximum values of the Group 13 element content in the upper injection-blocking layer is in the range of 100 nm to 1,000 nm in terms of resolution, chargeability, residual potential, and sensitivity in a photosensitive member.

Such an intermediate layer can be formed according to the same method as in the case of the upper injection-blocking layer, that is, for example, a plasma CVD method. In the formation of the intermediate layer according to such plasma CVD method, a mixing ratio of the raw material gases, gas pressure in a reaction vessel, discharge electric power, and the temperature of a substrate can be appropriately set. The optimum range of the pressure in the reaction vessel can be similarly appropriately selected in accordance with layer design. In addition, a local maximum value of the nitrogen atom content can be formed by changing the amount of a raw material gas containing nitrogen atoms to be introduced.

<Surface Protective Layer>

It is preferable that the surface protective layer 108 arranged in the surface region layer in the present invention has a free surface and be composed of a non-single-crystal silicon nitride film using silicon atoms and nitrogen atoms as base materials. The surface protective layer has one local maximum value of the nitrogen atom content in the thickness direction, has a low content of the Group 13 element in the periodic table, and imparts moisture resistance, resistance to continuous repeated use, high withstand voltage, resistance to service environments and durability to the photosensitive member. The local maximum value of the nitrogen atom content in the thickness direction, the shape of the local maximum value, the relationship between the local maximum value and the minimum value of the nitrogen atom content in the upper injection-blocking layer, the average nitrogen atom content of the surface protective layer, and the like are the same as in the intermediate layer.

If necessary, the surface protective layer may contain, for example, an oxygen atom, a hydrogen atom, or a halogen atom. Hydrogen atom and halogen atoms bind to unused bonding valences of constituent atoms such as silicon to improve the quality of the layer, in particular, the photoconductive properties and charge holding properties of the layer. From such a viewpoint, the hydrogen content is preferably 30 atm % to 70 atm %, more preferably 35 atm % to 65 atm %, or still more preferably 40 atm % to 60 atm % with respect to the total amount of constituent atoms. In addition, the halogen atom content, for example, the fluorine atom content is in the range of, for example, 0.01 atm % to 15 atm % (both inclusive), preferably 0.1 atm % to 10 atm %, or more preferably 0.6 atm % to 4 atm %. The thickness of the surface protective layer can be in the range of, for example, 10 nm to 3,000 nm, preferably 50 nm to 2,000 nm, or more preferably 100 nm to 1,000 nm. When the thickness is equal to or larger than 10 nm, the surface protective layer 108 is not lost owing to abrasion or the like during the use of a photosensitive member. When the thickness is 3,000 nm or less, an increase in residual potential is suppressed, and excellent electrophotographic properties can be obtained.

Such surface protective layer can be formed by means of, for example, a plasma CVD method. The formation of the surface protective layer by means of the plasma CVD method can be carried out by appropriately setting the temperature of a substrate and gas pressure in a reaction vessel as desired. For example, the substrate temperature (Ts) whose optimum range is appropriately selected in accordance with the layer design is in the range of preferably 150° C. to 350° C., more preferably 180° C. to 330° C., or still more preferably 200° C. to 300° C. The pressure in the reaction vessel whose optimum range is similarly appropriately selected in accordance with the layer design is in the range of 1.0×10⁻² Pa to 1.0×10³ Pa, preferably 5.0×10⁻² Pa to 5.0×10² Pa, or more preferably 1.0×10⁻¹ Pa to 1.0×10² Pa. The above-described ranges are exemplified as preferable numerical ranges for the substrate temperature and the gas pressure for forming the surface protective layer. However, those conditions are not determined independently or separately. Optimum values are preferably determined on the basis of mutual and organic relevance for forming a photosensitive member having desired properties.

An average nitrogen atom concentration (atm %) in a surface region layer having such layer structure preferably satisfies the relationship of 30 atm %≦N/(Si+N)≦7.0 atm % in terms of sensitivity.

In addition, it is preferable that the oxygen atom content and/or the fluorine atom content with respect to the total number of constituent atoms in the surface region layer have at least one local maximum value in the thickness direction of the layer for improving image quality and electric potential properties.

It should be noted that the content of each element such as oxygen, nitrogen, silicon, an Group 13 element in the periodic table, hydrogen or halogen described herein is determined by calculating a ratio of oxygen, nitrogen, silicon, the Group 13 element in the periodic table, hydrogen, or halogen atoms with respect to the total amount of atoms constituting the first upper injection-blocking layer (TBL-1), the intermediate layer, the second upper injection-blocking layer (TBL-2), the surface protective layer, or the like through measurement by means of secondary-ion mass spectrometry (SIMS).

<Substrate>

The substrate to be used in the present invention may be any one of a substrate composed of a conductive material and an insulating substrate at least a surface of which on a side on which a light-receiving layer is to be formed is subjected to conductive treatment.

Examples of a conductive substrate material include metals such as Al, Cr, Mo, In, Nb, Te, V, Ti, Pd, and Fe, and alloys of them such as stainless steel.

In addition, examples of an electrical insulating substrate material may include a film or sheet made of a synthetic resin such as polyester, polyethylene, polycarbonate, cellulose acetate, polypropylene, polyvinyl chloride, polystyrene, or polyamide, or glass or ceramic.

When an insulating material is used for the substrate, at least the surface of the substrate on a side on which a light-receiving layer is to be formed must be subjected to conductive treatment.

The substrate may be of a cylindrical or endless belt shape having a smooth surface or an irregular surface. The thickness of the substrate is appropriately determined in such a manner that such light-receiving member as desired can be formed. When flexibility is demanded for the light-receiving member like the substrate of an endless belt shape, the thickness of the substrate can be reduced to the extent that the substrate can sufficiently exert its function. However, the thickness of the substrate is typically 10 μm or more in terms of, for example, production, handling, and mechanical strength.

<Photoconductive Layer>

When a photoconductive layer is formed by means of, for example, a glow discharge method, the following procedure can be basically adopted. A raw material gas for supplying Si capable of supplying silicon atoms (Si), a raw material gas for supplying H capable of supplying hydrogen atoms (H) and, as required, a raw material gas for supplying X capable of supplying halogen atoms (X) are introduced in desired gas states into a reaction vessel the pressure in which can be reduced, to thereby cause glow discharge in the reaction vessel. Then, a layer composed of a-Si: H,X is formed on a predetermined substrate placed at a predetermined position in advance.

Hydrogen atoms in the photoconductive layer and halogen atoms to be added as required each compensate for unused bonding valences of silicon atoms to improve the quality of the layer, in particular, the photoconductive properties and charge holding properties of the layer.

The hydrogen atom content, which is not particularly limited, is preferably 10 to 40 atm % with respect to the sum of silicon and hydrogen atoms. It is preferable that the shape of the distribution of the content is adjusted appropriately by, for example, changing the content in relation to the wavelength of an exposure system. In particular, it is known that when the hydrogen atom content or the halogen atom content is increased to some extent, an optical band gap increases and a sensitivity peak shifts to the shorter wavelength side. Such expansion of the optical band gap is preferable when exposure at a short wavelength is employed. In this case, the hydrogen atom content is preferably 15 atm % or more with respect to the sum of silicon and hydrogen atoms.

Examples of a substance that can be effectively used as a gas for supplying Si include: gaseous substances such as SiH₄, Si₂H₆, Si₃H₈, and Si₄H₁₀; and silicon hydrides (silanes) capable of being gasified. Of those, SiH₄ and Si₂H₆ are preferable in terms of easiness of handling in the production of the layer, good efficiency of Si supply, and the like. Each of the gases may be used singly, or two or more of them may be mixed at a predetermined mixing ratio.

Furthermore, those gases can be mixed with a desired amount of one or more kinds of gases selected from H₂, He, and a silicon compound containing a hydrogen atom before the layer is formed in consideration of, for example, the controllability of the physical properties of the film and convenience in gas supply. Specific examples of a raw material gas for supplying a halogen atom include: a fluorine gas (F₂); an interhalogen compound such as BrF, ClF, ClF₃, BrF₃, BrF₅, IF₃, or IF₇; and a silicon fluoride such as SiF₄ or Si₂F₆.

It is sufficient to control, for example, the temperature of a substrate, the amount of a raw material gas, which is to be used for incorporating a halogen element into the photoconductive layer, to be introduced into a reaction vessel, the pressure of a discharge space, and discharge electric power in order to control the amount of the halogen element to be incorporated into the photoconductive layer.

In addition, atoms for controlling conductivity are preferably incorporated into the photoconductive layer in a nonuniform distribution state in the thickness direction of the photoconductive layer. This is effective in improving chargeability, reducing an optical memory effect, and increasing sensitivity because the travelling properties of carriers in the photoconductive layer are adjusted and secured to balance the travelling properties in a high level.

In general, the content of the atoms for controlling conductivity, which is not particularly limited, is preferably 0.05 to 5 atm ppm. In addition, a range at which light arrives can be controlled to be substantially free of any atom for controlling conductivity (in other words, no active addition is performed).

The content of the atoms for controlling conductivity may include a region where the content changes continuously or stepwise in the thickness direction, or may include a region in which the content is constant in the thickness direction.

The so called impurity in the semiconductor field can be exemplified as atoms for controlling conductivity. Atoms belonging to Group 13 in the periodic table (hereinafter abbreviated also as the Group 13 atom(s)) or an atom belonging to Group 15 in the periodic table (hereinafter abbreviated also as the Group 15 atom(s)) can be used as atoms for controlling conductivity.

Specific examples of the Group 13 atoms include boron (B), aluminum (Al), gallium (Ga), indium (In), and thallium (Tl). Of those, B, Al, and Ga are particularly suitable.

Specific examples of a raw material substance for introducing the Group 13 atoms include: raw material substances for introducing boron atoms including boron hydrides (such as B₂H₆, B₄H₁₀, B₅H₉, B₅H₁₁, B₆H₁₀, B₆H₁₂, and B₆H₁₄) and boron halides (such as BF₃, BCl₃, and BBr₃); AlCl₃; GaCl₃; Ga(CH₃)₃; InCl₃; and TlCl₃.

Specific examples of the Group 15 atoms include nitrogen (N), phosphorus (P), arsenic (As), antimony (Sb), and bismuth (Bi). Of those, P, As, and Sb are particularly suitable.

Specific examples of a raw material substance for introducing the Group 15 atoms that can be effectively used include raw material substances for introducing phosphorus atoms including phosphorus hydrides (such as PH₃ and P₂H₄) and phosphorus halides (such as PH₄I, PF₃, PF₅, PCl₅, PBr₃, PBr₅, and PI₃). In addition, examples of an effective raw material gas for introducing the Group 15 atoms include AsH₃, AsF₃, AsCl₃, AsBr₃, AsF₅, SbH₃, SbF₃, SbF₅, SbCl3, SbCl₅, BiH₃, BiCl₃, and BiBr₃.

In addition, such raw material gas for introducing atoms for controlling conductivity may be diluted with H₂ and/or He as required before use.

The thickness of the photoconductive layer is appropriately determined as desired in terms of, for example, desired electrophotographic properties and an economic effect, and is in the range of preferably 5 to 50 μm, more preferably 10 to 45 μm, or still more preferably 20 to 40 μm. When the thickness is equal to or larger than 5 μm, electrophotographic properties such as chargeability and sensitivity are practically sufficient. When the thickness does not exceed 50 μm, a time period for producing the photoconductive layer does not lengthen to result in an decrease in production cost.

The mixing ratio between a gas (such as a gas for supplying Si or a gas for supplying a halogen) and a diluent gas, gas pressure in a reaction vessel, discharge electric power, and substrate temperature are preferably set in an appropriate manner for forming a photoconductive layer having desired film properties.

The optimum range of the flow rate of at least one of H₂ and He to be used as diluent gases is appropriately selected in accordance with the layer design. The flow rate of He is controlled to be preferably 3 to 30 times, more preferably 4 to 15 times, or still more preferably 5 to 10 times as large as that of the gas for supplying Si. The pressure in the reaction vessel whose optimum range is similarly appropriately selected in accordance with the layer design is in the range of preferably 1×10⁻² Pa to 1×10³ Pa, more preferably 5×10⁻² Pa to 5×10² Pa, or still more preferably 1×10⁻¹ Pa to 2×10² Pa.

The discharge electric power is similarly appropriately selected from an optimum range in accordance with the layer design. A ratio of the discharge electric power (W) to the flow rate (mL/min (normal)) of the gas for supplying Si is set to fall within the range of preferably 0.5 to 8, or more preferably 2 to 6.

Furthermore, the substrate temperature whose optimum range is appropriately selected in accordance with the layer design is in the range of preferably 200° C. to 350° C., more preferably in the range of 210° C. to 330° C., or still more preferably in the range of 220° C. to 300° C.

The above-described ranges are exemplified as preferable numerical ranges for the substrate temperature and the gas pressure for forming the photosensitive layer. However, in general, conditions of forming the photosensitive layer are not determined independently or separately. Optimum values are preferably determined on the basis of mutual and organic relevance for forming a light-receiving member having desired properties.

<Lower Injection-Blocking Layer>

As shown in FIG. 1B of the present invention, it is effective to arrange the lower injection-blocking layer 104 that serves, to block the injection of charges from the side of the conductive substrate 101 as a layer on the substrate 101. The lower injection-blocking layer 104 has a function of blocking the injection of charges from the side of the substrate 101 to the side of the photoconductive layer 102 when the free surface of the photosensitive layer 102 is subjected to treatment to be charged in a certain polarity.

The lower injection-blocking layer 104 can be obtained by incorporating an, impurity for controlling conductivity together with silicon atoms as a base material. The lower injection-blocking layer 104 contains a relatively larger amount of the element for controlling conductivity than that of the photoconductive layer 102. An element belonging to Group 15 in the periodic table can be used as an impurity element to be incorporated into the lower injection-blocking layer 104. The content of the impurity element for controlling conductivity to be incorporated into the lower injection-blocking layer 104 is appropriately determined as desired in such a manner that the object of the present invention can be effectively achieved. The content is in the range of preferably 10 atm ppm to 10,000 atm ppm, more preferably 50 atm ppm to 7,000 atm ppm, or still more preferably 100 atm ppm to 5,000 atm ppm with respect to the total amount of the constituent atoms in the lower injection-blocking layer.

Furthermore, when incorporating nitrogen and oxygen into the lower injection-blocking layer 104, the adhesiveness between the lower injection-blocking layer 104 and the substrate 101 can be improved.

An ability to block charge injection can be obtained by optimally incorporating nitrogen and oxygen instead of incorporating an impurity element into the lower injection-blocking layer 104. Specifically, an excellent ability to block charge injection can be obtained by setting the sum of nitrogen and oxygen atoms to be incorporated into the entire layer region of the lower injection-blocking layer 104 to fall within the range of 0.1 atm % to 40 atm % with respect to the total amount of constituent atoms in the lower injection-blocking layer. In this case, the sum of nitrogen and oxygen atoms to be incorporated into the entire layer region of the lower injection-blocking layer 104 is more preferably in the range of 1.2 atm % to 20 atm % with respect to the total amount of the constituent atoms in the lower injection-blocking layer.

Further, hydrogen atoms are preferably incorporated into the lower injection-blocking layer 104. In this case, the hydrogen atoms incorporated compensate for unused bonding valences present in the layer to have an effect of improving the quality of the layer. The content of hydrogen atoms to be incorporated into the lower injection-blocking layer 104 is in the range of preferably 1 atm % to 50 atm %, more preferably 5 atm % to 40 atm %, or still more preferably 10 atm % to 30 atm % with respect to the total amount of the constituent atoms in the lower injection-blocking layer.

The thickness of the lower injection-blocking layer 104 in the present invention is in the range of preferably 100 nm to 5,000 nm, more preferably 300 nm to 4,000 nm, or still more preferably 500 nm to 3,000 nm in terms of, for example, desired electrophotographic properties and an economic effect. When the thickness is in the range of 100 nm to 5,000 nm, a sufficient ability to block the injection of charges from the substrate 101 can be obtained, and sufficient chargeability can be obtained. In addition, improvements of electrophotographic properties can be expected, and no detrimental effects such as an increase in residual potential occur.

The gas pressure in a reaction vessel, discharge electric power, and a substrate temperature must be appropriately set for forming the lower injection-blocking layer 104. In general, the temperature of the conductive substrate (Ts) whose optimum range is appropriately selected in accordance with the layer design is in the range of preferably 150° C. to 350° C., more preferably 180° C. to 330° C., or still more preferably 200° C. to 300° C.

In general, the pressure in the reaction vessel whose optimum range is similarly appropriately selected in accordance with the layer design is in the range of preferably 1×10⁻² Pa to 1×10³ Pa, more preferably 5×10⁻² Pa to 5×10² Pa, or still more preferably 1×10⁻¹ Pa to 1×10² Pa.

<Apparatus for Producing Electrophotographic Photosensitive Member>

Next, an apparatus for producing the photosensitive layer of the present invention and a method of forming the layer will be described in detail.

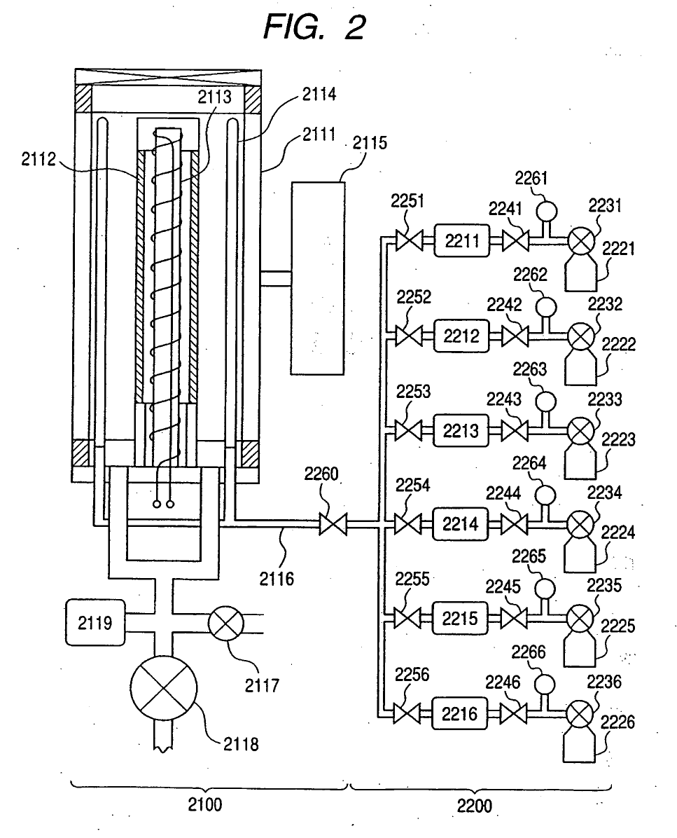

FIG. 2 is a schematic block diagram showing an example of an apparatus for producing an electrophotographic photosensitive member according to a high-frequency plasma CVD method using an RF band as a power source frequency (hereinafter abbreviated also as the RF-PCVD). The constitution of the production apparatus shown in FIG. 2 is as follows.

The apparatus mainly includes a deposition device 2100, a raw material gas-supplying device 2200, and an exhaust device (not shown) for reducing a pressure in a reaction vessel 2111. A cylindrical substrate 2112, a heater for heating the substrate 2113, and a raw material gas-introducing pipe 2114 are placed in the reaction vessel 2111 in the deposition device 2100. Furthermore, a high-frequency matching box 2115 is connected to the device.

The raw material gas-supplying device 2200 is composed of bombs 2221 to 2226 for raw material gases such as SiH₄, GeH₄, H₂, CH₄, B₂H₆, and PH₃, valves 2231 to 2236, 2241 to 2246, and 2251 to 2256, and massflow controllers 2211 to 2216. The bomb for each raw material gas is connected to the gas-introducing pipe 2114 in the reaction vessel 2111 via an auxiliary valve 2260.

A deposition film can be formed by means of the apparatus, for example, as follows.

At first, the cylindrical substrate 2112 is placed in the reaction vessel 2111. Then, the inside of the reaction vessel 2111 is evacuated by means of the exhaust device (not shown) (such as a vacuum pump). Subsequently, the temperature of the cylindrical substrate 2112 is controlled to be a predetermined temperature of 150° C. to 350° C. by means of the heater for heating the substrate 2113.

Before a raw material gas for forming a deposition film is caused to flow in the reaction vessel 2111, the fact that the valves 2231 to 2236 of the gas bombs and a leak valve 2117 of the reaction vessel are closed and the fact that the gas inflow valves 2241 to 2246, the gas outflow valves 2251 to 2256, and the auxiliary valve 2260 are opened are confirmed. Then, a main valve 2118 is opened so that the inside of each of the reaction vessel 2111 and a raw material gas pipe 2116 is exhausted.

Next, the auxiliary valve 2260 and the gas outflow valves 2251 to 2256 are closed when about 0.1 Pa or less is read on a vacuum gauge 2119. After that, the respective gases are introduced from the gas bombs 2221 to 2226 by opening the vales 2231 to 2236 of the raw material gas bombs, and then the pressure of each gas is adjusted to 0.2 MPa by means of each of pressure regulators 2261 to 2266. Next, the gas inflow valves 2241 to 2246 are gradually opened so that the respective gases are introduced into the massflow controllers 2211 to 2216.

After completing preparation for film formation, each layer is formed through the following procedures.

When the temperature of the cylindrical substrate 2112 reaches a predetermined temperature, one or more necessary valves out of the outflow valves 2251 to 2256 and the auxiliary valve 2260 are gradually opened. Then, predetermined gases are introduced from the gas bombs 2221 to 2226 into the reaction vessel 2111 via the raw material gas-introducing pipe 2114. Next, each of the massflow controllers 2211 to 2216 is used to adjust the flow rate of each raw material gas to a predetermined flow rate. At that time, the opening of the main valve 2118 is adjusted while looking at the vacuum gauge 2119 in such a manner that the pressure in the reaction vessel 2111 becomes a predetermined pressure of 1×10² Pa or less. After the internal pressure has been stabilized, the electric power of an RF power source having a frequency of 13.56 MHz (not shown) is set to be predetermined electric power, and the RF electric power is introduced into the reaction vessel 2111 through the high-frequency matching box 2115 to cause glow discharge. A raw material gas introduced into the reaction vessel is decomposed by the discharge energy, with the result that a deposition film mainly composed of predetermined silicon is formed on the cylindrical substrate 2112. After a film having a desired thickness has been formed, the supply of the RF electric power is stopped, and the one or more opened outflow valves are closed to stop the flow of a gas into the reaction vessel. Thus, the formation of the deposition film is completed.

A similar operation is repeated multiple times, with the result that a light-receiving layer having a desired multilayer structure is formed. It is needless to say that all the outflow valves for gases except a necessary gas must be closed in the formation of each layer. In addition, an operation is performed involving: closing the outflow valves 2251 to 2256; opening the auxiliary valve 2260; and fully opening the main valve 2118 in such a manner that the inside of the system is exhausted to a high vacuum once as required for preventing each gas from remaining in the reaction vessel 2111 or in the pipe communicating the outflow valves 2251 to 2256 to the reaction vessel 2111.

During layer formation, rotating the cylindrical substrate 2112 at a predetermined speed by means of a driving device (not shown) is also effective in uniformizing film formation.

Furthermore, it is needless to say that the above-described kinds of gas and valve operations are changed in accordance with conditions under which each layer is formed.

A means for heating the substrate is required to be used in vacuum. More specific examples of the heating element include: an electrical resistance heating element such as a winding heater of a sheath-like heater, a plate-like heater, or a ceramic heater; a heat radiation lamp heating element such as a halogen lamp or an infrared lamp; and a heating element on the basis of heat exchange means using a liquid, a gas, or, the like as a heating medium. A metal (such as stainless steel, nickel, aluminum, or copper), a ceramic, or a heat-resistant polymer resin, or the like can be used as a material for the surface of the heating means.

In addition to the foregoing, a method is employed involving: positioning a vessel for heating in addition to the reaction vessel; heating the substrate; and conveying the substrate into the reaction vessel in vacuum.

<Electrophotographic Device>

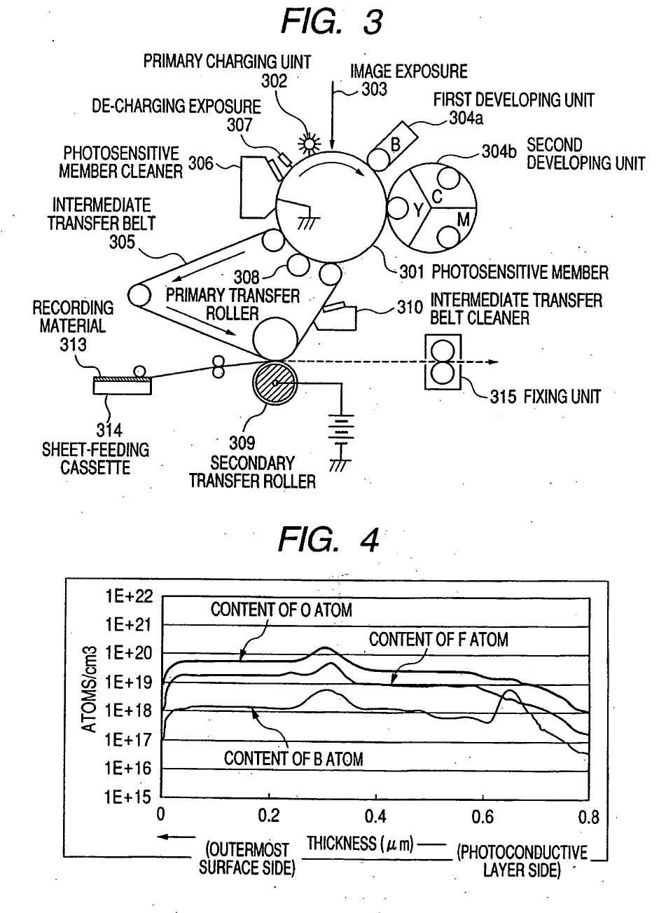

FIG. 3 is a schematic view showing an image forming apparatus for which the electrophotographic photosensitive member of the present invention can be suitably used.

FIG. 3 is a schematic view of a color image forming apparatus (a copying machine or a laser beam printer) utilizing an electrophotographic process in which an intermediate transfer belt 305 composed of a film-like dielectric belt is used to perform transfer.

In the image forming apparatus, a first image-bearing member is constituted by a photosensitive drum 301 composed of a rotating drum-type electrophotographic photosensitive member to be repeatedly used. An electrostatic latent image is formed on the surface of the first image-bearing member, and toner adheres to the electrostatic latent image to form a toner image. A primary charging unit 302 for uniformly charging the surface of the photosensitive drum 301 to a predetermined electric potential with a predetermined polarity and an image exposing device (not shown) for performing image exposure 303 on the surface of the charged photosensitive drum 301 to form an electrostatic latent image are arranged around the photosensitive drum 301. Furthermore, a first developing unit 304a for adhering black toner (B) to the formed electrostatic latent image, and a second developing unit 304b of a rotating type including a developing unit for adhering yellow toner (Y), a developing unit for adhering magenta toner (M), and a developing unit for adhering cyan toner (C) are arranged as developing units for adhering toner to the formed electrostatic latent image for development. Furthermore, a photosensitive member cleaner 306 for cleaning the photosensitive drum 301 after a toner image has been transferred onto the intermediate transfer belt 305 and de-charging exposure 307 for removing charges from the photosensitive drum 301 are arranged.

The intermediate transfer belt 305 is positioned to be driven through a nip portion in contact with the photosensitive drum 301, and a primary transfer roller 308 for transferring the toner image formed on the photosensitive drum 301 onto the intermediate transfer belt 305 is positioned inside the belt. A bias power source (not shown) for applying a primary transfer bias for transferring the toner image on the photosensitive drum 301 onto the intermediate transfer belt 305 is connected to the primary transfer roller 308. A secondary transfer roller 309 for transferring the toner image transferred on the intermediate transfer belt 305 onto a recording material 313 is positioned around the intermediate transfer belt 305 to be brought into contact with the lower surface portion of the intermediate transfer belt 305. A bias power source for applying a secondary transfer bias for transferring the toner image on the intermediate transfer belt 305 onto the recording material 313 is connected to the secondary transfer roller 309. In addition, an intermediate transfer belt cleaner 310 for cleaning transfer residual toner remaining on the surface of the intermediate transfer belt 305 after the toner image on the intermediate transfer belt 305 has been transferred onto the recording material 313 is positioned.

The image forming apparatus is additionally provided with a sheet-feeding cassette 314 for holding multiple recording materials 313 on each of which an image is to be formed and a conveying mechanism for conveying each of the recording materials 313 from the sheet-feeding cassette 314 through a nip portion where the intermediate transfer belt 305 and the secondary transfer roller 309 are brought into contact with each other. A fixing unit 315 for fixing the toner image transferred onto each of the recording materials 313 to the recording material 313 is arranged on a path along which the recording material 313 is conveyed.

A charging unit of a magnetic brush system or the like is used as the primary charging unit 302. A color separation/imaging exposure optical system for an original color image, a scanning exposure system by means of a laser scanner that outputs a laser beam modulated in accordance with a time series electrical digital pixel signal of image information, or the like is used as the image exposing device.

Next, the operation of the image forming apparatus will be described.

At first, as shown by an arrow in FIG. 3, the photosensitive drum 301 is rotated clockwise at a predetermined peripheral speed (process speed), and the intermediate transfer belt 305 is rotated counterclockwise at the same peripheral speed as that of the photosensitive drum 301.

In the course of the rotation of the photosensitive drum 301, the drum is uniformly charged by the primary charging unit 302 to a predetermined electric potential with predetermined polarity, and is then subjected to the image exposure 303. As a result, an electrostatic latent image corresponding to a first color component image (for example, a magenta component image) of a target color image is formed on the surface of the photosensitive drum 301. Next, the second developing unit rotates so that the developing unit for adhering magenta toner (M) to the electrostatic latent image is set at a predetermined position. As a result, the electrostatic latent image is developed with the magenta toner (M) as a first color. At this time, the first developing unit 304a does not operate. As a result, the unit does not act on the photosensitive drum 301, and there are no influences on the magenta toner image as the first color.

In the course of passing through the nip portion between the photosensitive drum 301 and the intermediate transfer belt 305, the magenta toner image as the first color thus formed and carried on the photosensitive drum 301 is sequentially intermediately transferred onto the outer peripheral surface of the intermediate transfer belt 305 by an electric field formed by the application of the primary transfer bias from the bias power source (not shown) to the primary transfer roller 308.

The surface of the photosensitive drum 301 that has already transferred the magenta toner image as the first color onto the intermediate transfer belt 305 is cleaned by the photosensitive member cleaner 306. Next, a toner image as a second color (for example, a cyan toner image) is formed on the cleaned surface of the photosensitive drum 301 in the same manner as in the toner image as the first color. The toner image as the second color is superimposed and transferred onto the surface of the intermediate transfer belt 305 onto which the toner image as the first color has been transferred. Hereinafter, a toner image as a third color (for example, a yellow toner image) and a toner image as a fourth color (for example, a black toner image) are sequentially superimposed and transferred onto the intermediate transfer belt 305 in a similar manner, so that a composite color toner image corresponding to the target color image is formed.

Next, each of the recording materials 313 is fed from the sheet-feeding cassette 314 to the nip portion where the intermediate transfer belt 305 and the secondary transfer roller 309 come in contact with each other at a predetermined timing. The secondary transfer roller 309 is brought into contact with the intermediate transfer belt 305, and the secondary transfer bias is applied from the bias power source to the secondary transfer roller 309. Thus, the composite color toner image superimposed and transferred onto the intermediate transfer belt 305 is transferred onto the recording material 313 as a second image-bearing member. After the completion of the transfer of the toner image onto the recording material 313, the transfer residual toner on the intermediate transfer belt 305 is cleaned by the intermediate transfer belt cleaner 310. The recording material 313 onto which the toner image has been transferred is introduced to the fixing unit 315 where the toner image is fixed to the recording material 313 by heating.

During the operation of the image forming apparatus, the secondary transfer roller 309 and the intermediate transfer belt cleaner 310 may be separated from the intermediate transfer belt 305 at the time of sequentially transferring the toner images as the first to fourth colors from the photosensitive member 301 onto the intermediate transfer belt 305.

Such color image forming apparatus according to electrophotography using an intermediate transfer belt has the following characteristics.

A first characteristic is such that color shift in which the positions at which toner images of respective colors are formed shift from each other in superimposition is reduced. In addition, as shown in FIG. 3, a toner image can be transferred from the intermediate transfer belt 305 without processing or controlling the recording material 313 (for example, holding the material by a gripper, adsorbing the material, or providing the material with curvature). As a result, any one of various recording materials can be used as the recording material 313. For example, a recording material selected from recording materials having various thicknesses ranging from thin paper (40 g/m² paper) to thick paper (200-g/m² paper) can be used as the recording material 313. In addition, any one of recording materials having various sizes can be used as the recording material 313 irrespective of a width or a length. Furthermore, an envelope, a postcard, label paper, or the like can be used as the recording material 313.

In addition, the intermediate transfer belt 305 is excellent in flexibility, hence the nip between the belt and the photosensitive drum 301 or the recording material 313 can be freely set. Therefore, the intermediate transfer belt 305 is characterized in that it has a high degree of freedom in design and its transfer efficiency or the like can be easily optimized.

As described above, an image forming apparatus using the intermediate transfer belt 305 has various advantages.

Hereinafter, the present invention will be described in more detail by way of examples and comparative examples. However, the present invention is by no means limited to these examples.

### EXAMPLE 1

A plasma CVD apparatus shown in FIG. 2 was used to superimpose deposition films composed of a lower injection-blocking layer, a photoconductive layer, a gradient-composition layer, and a surface layer in the stated order under the conditions shown in Table 1 on an aluminum cylinder (support), which had a diameter of 84 mm and a length of 381 mm and was subjected to mirror finish, to thereby produce a photosensitive member. All lower injection-blocking layers, photoconductive layers, and gradient-composition layers were produced under the conditions shown in Table 1 as common conditions. Surface layers were produced while the flow rate of an SiH₄ gas was changed in the range of 10 to 50 mL/min (normal), the flow rate of an N₂ gas was changed in the range of 20 to 1,000 mL/min (normal), and RF electric power was changed in the range of 150 to 300 W as shown in Table 2, and the mixing ratio between SiH₄ and N₂ and electric energy per amount of an SiH₄ gas were variously changed. Thus, photosensitive members 1-a to 1-h different from each other in nitrogen atom concentration in a surface layer were produced.

The photosensitive members 1-a to 1-h thus produced were evaluated as follows.

Electrophotographic properties were evaluated by means of an electrophotographic device iR C6800 manufactured by Canon Inc. remodeled for an experiment in which the charging unit was modified into a magnetic brush system, the charge polarity was adapted to be convertible, and the image exposure system was modified into an IAE system. In this case, two remodeled machines were used whose light sources for image exposure were modified into a blue light-emitting semiconductor laser having an oscillation wavelength of 405 nm and a light-emitting semiconductor laser having an oscillation wavelength of 660 nm, respectively.

Table 2 shows the measurement results.

(1) Actual Nitrogen Atom Concentration in Surface Layer

Analysis was made by means of secondary-ion mass spectrometry (SIMS) (IMS-4F, manufactured by CAMECA).

(2) Surface Layer Thickness

Thicknesses at 60 points (10 points in the peripheral direction at 6 positions in the axial direction) were measured by means of an interference thickness meter (MCPD-2000, manufactured by Otsuka Electronics Co., Ltd.), and the value obtained by dividing the value of (maximum value−minimum value) by an average thickness was defined as thickness unevenness (unit: %)

As the thickness unevenness exceeded 30%, hardness unevenness and resistance unevenness also increased. However, such increases caused no problems in practical use. The thickness unevenness in excess of 40% is not preferable because hardness unevenness and resistance unevenness are large and a phenomenon occurs in which a photosensitive member is partially abraded in the form of stripes owing to continuous use.

(3) Property of Transmitting Light Having a Wavelength of 405 nm

Spectral sensitivity characteristics were evaluated by means of the reciprocal of a light quantity necessary for causing optical attenuation from a certain dark potential to a certain light potential. That is, the attenuated amount of an electric potential per unit energy of light was defined as spectral sensitivity with respect to the exposure wavelength. The spectral sensitivity characteristics were evaluated according to a value obtained by normalizing the spectral sensitivity at each wavelength, which was measured with exposure wavelengths changed, with the spectral sensitivity at the wavelength at which the spectral sensitivity became maximum (a peak value of the spectral sensitivity). More specifically, the property of transmitting light having a wavelength of 405 nm was evaluated according to the spectral sensitivity with respect to light having a wavelength of 405 nm.

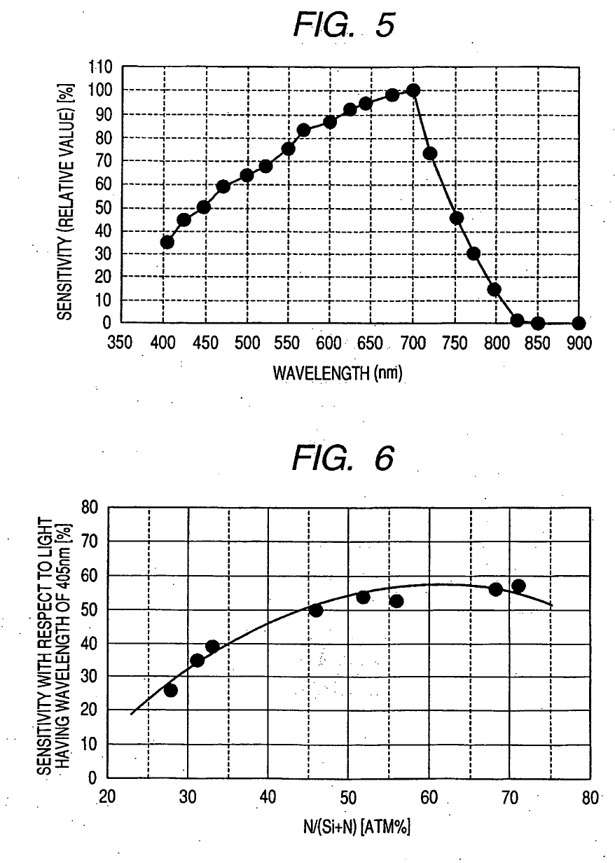

The term “spectral sensitivity” as used herein refers to the attenuated amount of a surface potential per unit light quantity (unit area) (unit: a V·cm²/μJ unit) when the surface of a photosensitive member is charged to a certain potential, for example, 450 V, and then irradiated with light beams having various wavelengths. FIG. 5 is a graph obtained by plotting the value normalized with the maximum value of the attenuated amount of electric potential versus wavelength as abscissa.

The attenuated amount of the surface potential was measured by the same method as the method by Kajita et al. (Academic Journal of Electrophotography, vol. 22, first edition, 1983). In the measurement of the attenuated amount of surface potential, a transparent electrode such as an ITO electrode was brought into close contact with the surface of a photosensitive member for reproducing behavior in a copying machine, and exposure and the application of voltage were performed in imitation of a sequence in the copying machine, to thereby measure a change in potential of the surface. When the electric potential of the surface is measured, an electric potential is preferably applied to the photosensitive member, which is regarded as a capacitor, connected to a known capacity in series because information on the chargeability of the photosensitive member can be acquired. The method by Kajita et al. involves sandwiching a transparent insulating film between a photosensitive member and an ITO electrode. Alternatively, a fixed capacitor can be used with an electrical circuit devised.

Specifically, the surface is irradiated with de-charging light (for example, 50 mW/cm²) for a certain time period (for example, 0.1 sec), and is then left for a certain time period (for example, 0.01 sec). After that, a voltage is applied (for about 20 msec, for example) to charge the surface. The electric potential of the surface of a conductor connected to the ITO electrode is measured by means of a potentiometer a certain time period (about 0.1 to 0.5 sec, for example, 0.25 sec) after the application of voltage has been stopped. This time period corresponds to the timing at which the portion of the photosensitive member to which an electric potential is applied reaches a developing unit in a copying machine, and the electric potential corresponds to an electric potential at the position of the developing unit. Next, in the same sequence, exposure is performed by means of light beams having various wavelengths between the application of voltage and the measurement of electric potential (for example, 0.1 sec after the application of a voltage). Similarly, an electric potential at the timing corresponding to the position of the developing unit is measured, and the difference between an electric potential in the case where light is applied and an electric potential in the case where light is not applied is calculated. This calculation corresponds to the measurement of the attenuated amount of an electric potential due to exposure light at the position of the developing unit.

The sensitivity of the electrophotographic photosensitive member of the present invention to be obtained by means of such a measurement method as described above is preferably 300 V·cm²/μJ or more, or more preferably 400 V·cm²/μJ or more.

Furthermore, FIG. 6 shows a graph showing the correlation between a nitrogen atom concentration in a surface layer and a spectral sensitivity with respect to light having a wavelength of 405 nm, obtained by plotting the sensitivity versus the concentration.

As is apparent from FIG. 6, there is the clear correlation between the nitrogen atom concentration and the spectral sensitivity with respect to light having a wavelength of 405 nm. It can be found that the spectral sensitivity with respect to light having a wavelength of 405 nm generally tends to increase, that is, adaptability to blue light-emitting semiconductor laser light tends to increase as the nitrogen atom concentration increases.

The value for the sensitivity required in an electrophotographic process depends on the performance of a laser device or an optical system to be used. Therefore, it is difficult to generally refer to the absolute value of the sensitivity. Here, the following was performed by the inventors of the present invention. The produced photosensitive member 1-b was placed in an image forming apparatus for evaluation, and a charging unit was so adjusted that a surface potential at the position of a developing unit would be −450 V (dark potential). After that, irradiation with image exposure light having a wavelength of 405 nm was carried out, and the light quantity of an image exposure light source was so adjusted that the surface potential would be −100 V (light potential). An exposure value at this time was defined as reference sensitivity.

Any other photosensitive members were similarly placed in an image forming apparatus for evaluation, and the sensitivity was judged to be insufficient when an electric potential resulting from irradiation with image exposure light having a wavelength 405 nm at the reference sensitivity was not −100 V or less.

Thus, as a result of various studies on the sensitivity made by the inventors of the present invention, it has been found that a photosensitive member preferably has a sensitivity of 30% or more, or more preferably 40% or more as an index normalized with the peak value of the spectral sensitivity as shown in FIG. 6. Accordingly, as shown in FIG. 6, it has been revealed that if the nitrogen atom concentration in the surface layer of a photosensitive member having such sensitivity is set to be preferably 30 atm % or more, or more preferably 35 atm % or more, an additional effect is exhibited such that the photosensitive member is provided with sensitivity with respect to laser light having a wavelength as short as about 405 nm such as blue light-emitting semiconductor laser light.

On the other hand, as is apparent from Table 2, the photosensitive member 1-g has large thickness unevenness, and it has been found to be desirable that the nitrogen concentration in a surface layer is not too high. From such a viewpoint, a nitrogen atom concentration in a surface layer is preferably 7.0 atm % or less, or more preferably 60 atm % or less.

TABLE 1

| | | | Surface region layer | | | | | |
|---|---|---|---|---|---|---|---|---|
| | | | Gradient-composition layer | | | Surface layer | | |
| | | | | | Local | | | Local |
| | | | Local | Local | maximum | Local | Local | maximum |
| | Lower | | maximum | maximum | value | maximum | maximum | value |
| | injection- | | value pre- | value | post- | value pre- | value | post- |
| Kind of | blocking | Photoconductive | forming | forming | forming | forming | forming | forming |
| gas/Condition | layer | layer | region | region | region | region | region | region |
| SiH₄[mL/min(normal)] | 150 | 200 | 200→130 | 130→100 | 100→50, | 50, 25, or | 50, 25, or | 50, 25, or |
| | | | | | 25, or 10 | 10 | 10 | 10 |
| H₂[mL/min(normal)] | 600 | 1200 | 0 | 0 | 0 | 0 | 0 | 0 |
| B₂H₆[ppm(with | 0 | 0 | 0 | 2000 | 0 | 0 | 200 | 0 |
| respect to SiH₄)] | | | | | | | | |
| NO[%(with respect to | 8 | 0 | 0 | 0 | 0 | 0 | 0 | 0 |
| SiH₄)] | | | | | | | | |
| N₂[mL/min(normal)] | 0 | 0 | 0→12 | 12→15 | 15→20, | 20, 100, | 20, 100, | 20, 100, |
| | | | | | 100, 250, | 250, 300, | 250, 300, | 250, 300, |
| | | | | | 300, 300, | 300, 500, | 300, 500, | 300, 500, |
| | | | | | 500, or | or 1000 | or 1000 | or 1000 |
| | | | | | 1000 | | | |
| CH₄[mL/min(normal)] | 600 | 0 | 0 | 0 | 0 | 0 | 0 | 0 |
| Support | 270 | 260 | 220 | 220 | 220 | 220 | 220 | 220 |
| temperature[° C.] | | | | | | | | |
| Pressure[Pa] | 75 | 78 | 52 | 52 | 52 | 50 | 50 | 50 |
| RF electric power[W] | 150 | 500 | 250 | 250 | 250 | 150, 200, | 150, 200, | 150, 200, |
| | | | | | | 250, or | 250, or | 250, or |
| | | | | | | 300 | 300 | 300 |
| Thickness[μm] | 2 | 30 | 0.05 | 0.05 | 0.05 | 0.25 | 0.05 | 0.3 |

TABLE 2

| | | | | | | Thickness | |
|---|---|---|---|---|---|---|---|
| | SiH₄ | N₂ | | | Sensitivity with | unevenness of | Comparison |
| Photosensitive | [mL/min | [mL/min | Power | N/(Si + N) | respect to light having | surface | with standard |
| member | (normal)] | (normal)] | (W) | atm % | a wavelength of 405 nm % | layer % | sensitivity |
| Example 1-a | 50 | 300 | 300 | 27 | 24 | 11 | C |
| Example 1-b | 50 | 500 | 250 | 34 | 41 | 12 | B |
| Example 1-c | 50 | 1000 | 250 | 52 | 54 | 9 | B |
| Example 1-d | 25 | 250 | 200 | 45 | 49 | 12 | B |
| Example 1-e | 25 | 500 | 200 | 60 | 56 | 12 | B |
| Example 1-f | 10 | 100 | 200 | 70 | 58 | 33 | B |
| Example 1-g | 10 | 500 | 200 | 73 | 60 | 42 | B |
| Example 1-h | 10 | 20 | 150 | 30 | 31 | 11 | B |

### EXAMPLE 2

In order to provide a layer constitution shown in FIG. 1B, a plasma CVD apparatus shown in FIG. 2 was used to sequentially superimpose deposition films composed of a lower injection-blocking layer, a photoconductive layer, a gradient-composition layer, and a surface layer under the conditions shown in Table 3 on an aluminum cylinder (support), which had a diameter of 84 mm and a length of 381 mm and was subjected to mirror finish, to thereby produce a photosensitive member.

In that case, in the formation of a gradient-composition layer after the formation of a local maximum value in the gradient-composition layer, a change in composition of the gradient-composition layer was made partially discontinuous by changing RF electric power, to thereby produce photosensitive members 2-a to 2-h with Max %) and Min(%) of reflectivity changed, where the nitrogen content tended to increase as the RF electric power increases.

Each of the photosensitive members 2-a to 2-h thus produced was set in an electrophotographic device iR C6800 manufactured by Canon Inc. remodeled for the experiment in which the charging unit was modified into a magnetic brush system, the charge polarity was adapted to be convertible, the image exposure system was modified into an IAE system, the light source for image exposure was modified into a blue light-emitting semiconductor laser having an oscillation wavelength of 405 nm, and the optical system for image exposure was modified in such a manner that the drum surface irradiation spot diameter would be adjustable. Then, a durability test was performed involving printing a half tone image on 1,000,000 sheets to evaluate image density unevenness.

The evaluation was performed by ranking the electrophotographic photosensitive members according to the following judgment criteria using the density unevenness level of an initial image as a reference. Table 4 shows the evaluation results.
A: An extremely good level at which the density unevenness level of an initial image is maintained.
B: Density unevenness is slightly more remarkable than the density unevenness level of an initial image, but causes no problem in practical use.

Table 4 shows that image density unevenness due to abrasion can be reduced when the maximum value and minimum value of reflectivity satisfy the relationship of 0%≦Max(%)≦20% and the relationship of 0≦(Max−Min)/(100−Max)≦0.15.

TABLE 3

| | | | Surface region layer | | | | | |
|---|---|---|---|---|---|---|---|---|
| | | | Gradient-composition layer | | | Surface layer | | |
| | | | Local | | Local | Local | | Local |
| | | | maximum | Local | maximum | maximum | Local | maximum |
| | Lower | | value | maximum | value | value | maximum | value |
| | injection- | | pre- | value | post- | pre- | value | post- |
| | blocking | Photoconductive | forming | forming | forming | forming | forming | forming |
| Kind of gas/Condition | layer | layer | region | region | region | region | region | region |
| SiH₄[mL/min(normal)] | 150 | 200 | 200→150 | 150→130 | 130→10 | 10 | 10 | 10 |
| H₂[mL/min(normal)] | 600 | 1200 | 0 | 0 | 0 | 0 | 0 | 0 |
| B₂H₆[ppm(with respect to | 0 | 0 | 0 | 1500 | 0 | 0 | 250 | 0 |
| SiH₄)] | | | | | | | | |
| NO[%(with respect to SiH₄)] | 8 | 0 | 0 | 0 | 0 | 0 | 0 | 0 |
| N₂[mL/min(normal)] | 0 | 0 | 0→30 | 30→50 | 50→100 | 100 | 100 | 100 |
| CH₄[mL/min(normal)] | 600 | 0 | 0 | 0 | 0 | 0 | 0 | 0 |
| Support temperature [° C.] | 270 | 260 | 220 | 220 | 220 | 220 | 220 | 220 |
| Pressure[Pa] | 75 | 78 | 52 | 52 | 52 | 50 | 50 | 50 |
| RF power[W] | 150 | 500 | 250 | 250 | 200→300 | 200 | 200 | 200 |
| Thickness[μm] | 2 | 30 | 0.1 | 0.05 | 0.1 | 0.2 | 0.01 | 0.4 |

TABLE 4

| | | | | Half tone |
|---|---|---|---|---|
| | | | | image |
| Photosensitive | | | (Max − Min)/ | density |
| member | Max(%) | Min(%) | (100 − Max) | unevenness |
| Example 2-a | 15 | 3.95 | 0.13 | B |
| Example 2-b | | 2.25 | 0.15 | B |
| Example 2-c | | 0.55 | 0.17 | C |
| Example 2-d | 20 | 10.4 | 0.12 | B |
| Example 2-e | | 8 | 0.15 | B |
| Example 2-f | | 5.6 | 0.18 | C |
| Example 2-g | 25 | 17.5 | 0.1 | C |
| Example 2-h | 0 | 0 | 0 | B |

### EXAMPLE 3

In order to provide a layer constitution shown in FIG. 1B, a plasma CVD apparatus shown in FIG. 2 was used to superimpose deposition films composed of a lower injection-blocking layer, a photoconductive layer, a gradient-composition layer, and a surface region layer in the stated order under the conditions shown in Table 5 on an aluminum cylinder (support), which had a diameter of 84 mm and a length of 381 mm and was subjected to mirror finish, to thereby produce a photosensitive member. In this case, as shown in Table 5, a boron atom concentration (boron is an Group 13 element in the periodic table) was caused to have a local maximum value by introducing a B₂H₆ gas during the formation of a gradient-composition layer and a surface layer.

A B₂H₆ gas was introduced at a certain flow late into a local maximum value forming region in Table 5 for a predetermined time period. As a result, SIMS measurement confirmed that the boron atoms had a local maximum value as shown in FIG. 7.

The local maximum values of the Group 13 element in the periodic table (boron atom) were 5.3×10¹⁹ atoms/cm³ and 1.1×10¹⁹ atoms/cm³ from the photoconductive layer side. The interval between the local maximum values of the Group 13 element in the periodic table (boron atom) was 240 nm.

In addition, the amount of nitrogen represented by N/(Si+N) was 55 atm %.

In addition, the minimum value (Min) and maximum value (Max) of reflectivity (%) in the wavelength range of 350 nm to 680 nm are 8% and 15%, respectively, and satisfy the relationship of 0%≦Max(%)≦20% and the relationship of 0≦(Max−Min)/(100−Max)≦0.15.

TABLE 5

| | | | Gradient-composition layer | | | Surface layer | | |
|---|---|---|---|---|---|---|---|---|
| | | | Local | | Local | Local | | Local |
| | | | maximum | Local | maximum | maximum | Local | maximum |
| | Lower | | value | maximum | value | value | maximum | value |
| | injection- | | pre- | value | post- | pre- | value | post- |
| | blocking | Photoconductive | forming | forming | forming | forming | forming | forming |
| Kind and flow rate of gas | layer | layer | region | region | region | region | region | region |
| SiH₄[mL/min(normal)] | 110 | 200 | 200→160 | 160→130 | 130→30 | 30 | 30 | 30 |
| H₂[mL/min(normal)] | 500 | 800 | 0 | 0 | 0 | 0 | 0 | 0 |
| B₂H₆[ppm(with respect to | 0 | 0 | 0 | 1200 | 0 | 0 | 250 | 0 |
| SiH₄)] | | | | | | | | |
| N₂[mL/min(normal)] | 0 | 0 | 0→150 | 150→180 | 180→400 | 400 | 400 | 400 |
| CH₄[mL/min(normal)] | 400 | 0 | 0 | 0 | 0 | 0 | 0 | 0 |
| Substrate temperature {° C.} | 260 | 260 | 220 | 220 | 220 | 220 | 220 | 220 |
| Pressure in reaction vessel | 64 | 79 | 60 | 60 | 60 | 60 | 60 | 60 |
| {Pa} | | | | | | | | |
| High-frequency power {W} | 200 | 600 | 250 | 250 | 250 | 250 | 250 | 250 |
| 13.56 MHz | | | | | | | | |
| Thickness{μm} | 3 | 32 | 0.03 | 0.02 | 0.04 | 0.15 | 0.01 | 0.5 |

### COMPARATIVE EXAMPLE 1

In order to provide a layer constitution shown in FIG. 1B, a plasma CVD apparatus shown in FIG. 2 was used to superimpose deposition films composed of a lower injection-blocking layer, a photoconductive layer, a upper injection-blocking layer, and a surface layer in the stated order on an aluminum cylinder (support), which had a diameter of 84 mm and a length of 381 mm and was subjected to mirror finish, to thereby produce an electrophotographic photosensitive member. In this case, the lower injection-blocking layer and the photoconductive layer were produced under the same conditions as those of Table 5 of Example 1, and the upper injection-blocking layer and the surface layer were deposited under the conditions shown in Table 6. A B₂H₆ gas was introduced into the upper injection-blocking layer to provide the boron atom concentration of a Group 13 element in the periodic table with a local maximum value. The local maximum value of the content of the Group 13 element in the periodic table (boron atom) in that case was 2.1×10¹⁸ atoms/cm³.

In this comparative example, no gradient-composition layer was formed, and no local maximum value of the content of the Group 13 element in the periodic table was formed in the surface layer.

In addition, the minimum value (Min) and maximum value (Max) of reflectivity (%) in the wavelength range of 350 nm to 680 nm are 8% and 30%, respectively, and do not satisfy the relationship of 0%≦Max(%)≦20% and the relationship of 0≦(Max−Min)/(100−Max)≦0.15.

TABLE 6

| | Upper | |
|---|---|---|
| | injection- | |
| | blocking | Surface |
| Kind of gas/Condition | layer | layer |
| SiH₄[mL/min(normal)] | 150 | 30 |
| B₂H₆[ppm(with respect to | 1200 | 0 |
| SiH₄)] | | |
| N₂[mL/min(normal)] | 160 | 400 |
| Support temperature [° C.] | 220 | 220 |
| Pressure[Pa] | 60 | 60 |
| RF power[W] | 250 | 250 |
| Thickness[μm] | 0.15 | 0.6 |

Each of the photosensitive members obtained in Example 3 and Comparative Example 1 was set in the above image forming apparatus in which the light source for image exposure was modified into a blue light-emitting semiconductor laser having an oscillation wavelength of 405 nm, and was then evaluated for the following evaluation items.

(1) Resolution

A test chart in which alphabets (A to Z) and complicated Chinese characters (such as “Den” (meaning “electricity” in Japanese) and “Kyo” (meaning “surprise” in Japanese)) each having a two-point size or a three-point size were arranged at a resolution of 1,200 dpi was created by means of a personal computer. A photosensitive member was evaluated for resolution by means of an image obtained by printing out the test chart. Specifically, the outputted image was read by means of a scanner (CanoScan 9900F manufactured by Canon Inc.) at a resolution of 1,600 dpi. Then, the read image data and the original data on the test chart were compared with each other in order to calculate the area of misalignment portions (a thick portion or a thin portion) from a character on the test original. The photosensitive member was evaluated for resolution on the basis of the calculated value. The evaluation was performed by ranking the electrophotographic photosensitive members through relative evaluation where the value for the photosensitive member in Comparative Example 1 was regarded as a reference (100%).
A: An extremely good level at which a value is less than 80% of the reference.
B: A good level at which a value is 80% or more and less than 95% of the reference.
C: A level at which a value is comparable to the reference.
   (2) Chargeability

Each of the produced electrophotographic photosensitive members was placed in an electrophotographic device to be charged. The dark surface potential of the electrophotographic photosensitive member was measured by means of a surface potentiometer placed at the position of a developing unit, and was defined as chargeability. In this case, charging conditions (such as a DC voltage to be applied to a charging unit, a superimposed AC amplitude, and a frequency) were kept constant for comparison. The evaluation was performed by ranking the electrophotographic photosensitive members on the basis of the following judgment criteria where the photosensitive member shown in Comparative Example 1 was used as a reference.
A: An extremely good level at which chargeability increases by 10% or more as compared with the reference.
B: A good level at which chargeability increases by 5% or more as compared with the reference.
C: A level at which chargeability is comparable to the reference.
   (3) Residual Potential

A charging unit was adjusted in such a manner that a surface potential at the position of a developing unit would be −450 V (dark potential). After that, each of the produced electrophotographic photosensitive members was irradiated with image exposure having the light quantity of an image exposure light source adjusted to be maximum. Then, the surface potential of the electrophotographic photosensitive member was measured by means of a surface potentiometer placed at the position of the developing unit, and was defined as a residual potential. The evaluation was performed by ranking the electrophotographic photosensitive members on the basis of the following judgment criteria where the photosensitive member shown in Comparative Example 1 was used as a reference.
A: An extremely good level at which a residual potential reduces by 10% or more as compared with the reference.
B: A good level at which a residual potential reduces by 5% or more as compared with the reference.
C: A level at which a residual potential is comparable to the reference.
   (4) Sensitivity

A charging unit was so adjusted that a surface potential at the position of a developing unit would be −450 V (dark potential). After that, each of the produced electrophotographic photosensitive members was irradiated with image exposure light of the light quantity of an image exposure light source adjusted in such a manner that the surface potential would be −100 V (light potential). An exposure value at this time was defined as a sensitivity. The evaluation was performed by ranking the electrophotographic photosensitive members on the basis of the following judgment criteria where the photosensitive member shown in Comparative Example 1 was used as a reference.
A: An extremely good level at which a sensitivity increases by 10% or more as compared with the reference.
B: A good level at which a sensitivity increases by 5% or more as compared with the reference.
C: A level at which a sensitivity is comparable to the reference.
   (5) Electric Potential Unevenness

The in-plane distribution of the dark potential and light potential of each of the produced electrophotographic photosensitive members were measured in a state in which a charging unit was so adjusted that a dark potential at the position of a developing unit would be −450 V and the light quantity of an image exposure light source was adjusted in such a manner that a light potential at the position of the developing unit would be −100 V. Then, a difference between the maximum value and the minimum value was defined as electric potential unevenness. The evaluation was performed by ranking the electrophotographic photosensitive members on the basis of the following judgment criteria where the photosensitive member shown in Comparative Example 1 was used as a reference.
A: An extremely good level at which electric potential unevenness reduces by 10% or more as compared with the reference.
B: A good level at which electric potential unevenness reduces by 5% or more as compared with the reference.
C: A level at which electric potential unevenness is comparable to the reference.
   (6) Optical-Memory

The difference in surface potential between a non-image-exposure state and a state in which an electrophotographic photosensitive member was charged again after image exposure was measured once by means of a similar electric potential sensor in a state in which a, charging unit was so adjusted that a dark potential at the position of a developing unit would be −450 V and the light quantity of an image exposure light source was so adjusted that a light potential at the position of the developing unit would be −100 V. The measured potential difference was defined as an optical memory. The evaluation was performed by ranking the electrophotographic photosensitive members on the basis of the following judgment criteria where the photosensitive member shown in Comparative Example 1 was used as a reference.
A: An extremely good level at which an optical memory reduces by 10% or more as compared with the reference.
B: A good level at which an optical memory reduces by 5% or more as compared with the reference.
C: A level at which an optical memory is comparable to the reference.
   (7) Property of Transmitting Light Having Wavelength of 405 nm

The reciprocal of a light quantity necessary for causing optical attenuation from a certain dark potential to a certain light potential, that is, the attenuated amount of an electric potential per unit energy of light was defined as spectral sensitivity with respect to the exposure wavelength. The spectral sensitivity characteristics were evaluated according to the value obtained by normalizing the spectral sensitivity at each wavelength, which was measured with exposure wavelengths changed, with the spectral sensitivity at the wavelength at which the spectral sensitivity became maximum (a peak value of the spectral sensitivity). More specifically, the property of transmitting light having a wavelength of 405 nm was evaluated by means of the spectral sensitivity with respect to light having a wavelength of 405 nm.

(8) Cleaning Property

The cleaning property was evaluated by means of the pressure of a cleaning blade at which cleaning residual toner started to generate. Specifically, an experiment was carried out in which the surface of a photosensitive member was observed after extensive operation (running test) of printing 1,000 sheets of A4 copy paper had been performed and the presence or absence of cleaning residual toner was judged. This experiment was repeated while the pressure of a cleaning blade was gradually lowered. Thus, the pressure of the cleaning blade at which cleaning residual toner started to generate was investigated. The evaluation was performed by ranking the electrophotographic photosensitive members through relative evaluation where the value for the photosensitive member shown in Comparative Example 1 was used as a reference (100%). The lower the pressure of the cleaning blade at which cleaning residual toner started to generate, the wider the latitude of cleaning is. Therefore, it can be seen that low pressure results in an excellent cleaning property.
A: An extremely good level at which a value is less than 80% of the reference.
B: A good level at which a value is 80% or more and less than 95% of the reference.
C: A level at which a value is comparable to the reference.

Table 7 shows the results obtained through the above evaluation together with the results of Comparative Example 1.

TABLE 7

| | | | | | Electric | | |
|---|---|---|---|---|---|---|---|
| | | | Residual | | potential | Optical | Cleaning |
| | Resolution | Chargeability | potential | Sensitivity | unevenness | memory | Property |
| Example 3 | A | A | A | B | B | B | C |
| Comparative | C | C | C | C | C | C | C |
| example 1 | | | | | | | |

The results in Table 7 show that the resolution of an image of 1,200 dpi increases with a blue light-emitting semiconductor laser (405 nm). Accordingly, it has been revealed <that resolution can be increased by causing two local maximum values of the Group 13 element content to be present in the surface region layer, and the original effect to be exhibited by reducing the spot diameter is sufficiently exerted.

In addition, when producing a photosensitive member so that all the requirements of the present invention would be satisfied as in the surface region layer of Example 3, the electric potential properties are improved, and in particular, the effects of improving chargeability and residual potential are obtained.

### EXAMPLE 4

In order to provide a layer constitution shown in FIG. 1B, a plasma CVD apparatus shown in FIG. 2 was used to superimpose deposition films composed of a lower injection-blocking layer, a photoconductive layer, a gradient-composition layer, and a surface layer in the stated order under the conditions shown in Table 8 on an aluminum cylinder (support), which had a diameter of 84 mm and a length of 381 mm and was subjected to mirror finish, to thereby produce an electrophotographic member.

In that case, as shown in Table 8, the flow rate of a B₂H₆ gas to be introduced into the local maximum value forming region of each of the gradient-composition layer and the surface layer was varied to change the local maximum value of the concentration of boron atoms as a Group 13 element in the periodic table. In a photosensitive member 4-a, the flow rates of the B₂H₆ gas were set to be 120 and 100 [mL/min (normal)], respectively; in a photosensitive member 4-b, 110 and 100 [mL/min (normal)], respectively; and in a photosensitive member 4-c, 100 and 100 [mL/min (normal)], respectively; in each of photosensitive members 4-d to 4-g, 130 and 80 [mL/min (normal)], respectively.

Furthermore, the flow rate of a B₂H₆ gas to be introduced into each of the local maximum value post-forming region of the gradient-composition layer and the local maximum value pre-forming region of the surface layer was varied to change the minimum value of the Group 13 element content present between two adjacent local maximum values. In each of the photosensitive members 4-a to 4-c, the flow rate of the B₂H₆ gas was set to be 30 [mL/min (normal)]; in the photosensitive member 4-d, 70 [mL/min (normal)]; in the photosensitive member 4-e, 60 [mL/min (normal)]; in the photosensitive member 4-f, 50 [mL/min (normal)]; and in the photosensitive member 4-g, 0 [mL/min (normal)]. Table 11 shows the local maximum values and the minimum values created thus.

Each of the produced photosensitive members was evaluated in the same manner as in Example 1.

Table 12 shows the evaluation results.

TABLE 8

| | | | Gradient-composition layer | | | Surface layer | | |
|---|---|---|---|---|---|---|---|---|
| | | | Local | | Local | Local | | Local |
| | | | maximum | Local | maximum | maximum | Local | maximum |
| | Lower | | value | maximum | value | value | maximum | value |
| | injection- | | pre- | value | post- | pre- | value | post- |
| | blocking | Photoconductive | forming | forming | forming | forming | forming | forming |
| Kind and flow rate of gas | layer | layer | region | region | region | region | region | region |
| SiH₄{mL/min(normal)} | 110 | 200 | 200→160 | 160→130 | 130→10 | 10 | 10 | 10 |
| H₂{mL/min(normal)} | 500 | 800 | 0 | 0 | 0 | 0 | 0 | 0 |
| B₂H₆{ppm} (with respect to | 0 | 0 | 0 | 100, | 0, 30, | 0, 30, | 80 or | 0 |
| SiH₄) | | | | 110, | 50, 60, | 50, 60, | 100 | |
| | | | | 120, or | or 70 | or 70 | | |
| | | | | 130 | | | | |
| N₂{mL/min(normal)} | 0 | 0 | 0→150 | 150→180 | 180→400 | 400 | 400 | 400 |
| CH₄{mL/min(normal)} | 400 | 0 | 0 | 0 | 0 | 0 | 0 | 0 |
| Substrate temperature {° C.} | 260 | 260 | 220 | 220 | 220 | 220 | 220 | 220 |
| Pressure in reaction vessel | 64 | 79 | 60 | 60 | 60 | 60 | 60 | 60 |
| {Pa} | | | | | | | | |
| High-frequency power | 200 | 600 | 250 | 250 | 250 | 200 | 200 | 200 |
| {W} 13.56 MHz | | | | | | | | |
| Thickness{μm} | 3 | 32 | 0.04 | 0.02 | 0.05 or | 0.15 | 0.02 | 0.5 |
| | | | | | 0.06 | | | |

### EXAMPLE 5

In order to provide a layer constitution shown in FIG. 1B, a plasma CVD apparatus shown in FIG. 2 was used to superimpose deposition films composed of a lower injection-blocking layer, a photoconductive layer, a gradient-composition layer, and a surface layer in the stated order under the conditions shown in Table 9 on an aluminum cylinder (support), which had a diameter of 84 mm and a length of 381 mm and was subjected to mirror finish, to thereby produce an electrophotographic photosensitive member.

In Example 5, a thickness was changed by performing a treatment in which a deposition time for forming a local maximum value pre-forming region in the surface layer was changed, to thereby set the distance between two local maximum values of the Group 13 element content to be distributed in the gradient-composition layer and the surface layer to fall within the range of 8.9 nm to 1,200 nm. The thickness of the local maximum value pre-forming region in the surface layer was 0.01 μm in a photosensitive member 5-a, 0.03 μm in a photosensitive member 5-b, 0.05 μm in a photosensitive member 5-c, 0.89 μm in a photosensitive member 5-d, 0.93 μm in a photosensitive member 5-e, or 1.13 μm in a photosensitive member 5-f.

Table 11 shows the content and the local maximum value in that case.

Each of the produced photosensitive members was evaluated in the same manner as in Example 3.

Table 12 shows the evaluation results.

TABLE 9

| | | | Gradient-composition layer | | | Surface layer | | |
|---|---|---|---|---|---|---|---|---|
| | | | Local | | Local | Local | | Local |
| | | | maximum | Local | maximum | maximum | Local | maximum |
| | Lower | | value | maximum | value | value | maximum | value |
| | injection- | | pre- | value | post- | pre- | value | post- |
| | blocking | Photoconductive | forming | forming | forming | forming | forming | forming |
| Kind and flow rate of gas | layer | layer | region | region | region | region | region | region |
| SiH₄{mL/min(normal)} | 110 | 200 | 200→160 | 160→130 | 130→10 | 10 | 10 | 10 |
| H₂{mL/min(normal)} | 500 | 800 | 0 | 0 | 0 | 0 | 0 | 0 |
| B₂H₆{ppm} (with respect to | 0 | 0 | 0 | 1000 | 0 | 5 | 300 | 0 |
| SiH₄) | | | | | | | | |
| N₂{mL/min(normal)} | 0 | 0 | 0→150 | 150→180 | 180→400 | 400 | 400 | 400 |
| CH₄{mL/min(normal)} | 400 | 0 | 0 | 0 | 0 | 0 | 0 | 0 |
| Substrate temperature {° C.} | 260 | 260 | 220 | 220 | 220 | 220 | 220 | 220 |
| Pressure in reaction vessel | 64 | 79 | 60 | 60 | 60 | 60 | 60 | 60 |
| {Pa} | | | | | | | | |
| High-frequency power {W} | 200 | 600 | 250 | 250 | 250 | 200 | 200 | 200 |
| 13.56 MHz | | | | | | | | |
| Thickness{μm} | 3 | 32 | 0.03 | 0.02 | 0.05 | 0.01, | 0.02 | 0.5 |
| | | | | | | 0.03, 0.05, | | |
| | | | | | | 0.89, 0.93, | | |
| | | | | | | or 1.13 | | |

### EXAMPLE 6

In order to provide a layer constitution shown in FIG. 1B, a plasma CVD apparatus shown in FIG. 2 was used to sequentially superimpose deposition films composed of a lower injection-blocking layer, a photoconductive layer, a gradient-composition layer, and a surface layer under the conditions shown in Table 10 on an aluminum cylinder (support), which had a diameter of 84 mm and a length of 381 mm and was subjected to mirror finish, to thereby produce an electrophotographic photosensitive member.

In Example 6, photosensitive members were produced under the conditions opposite to those of Example 3 with the result that the flow rate of a B₂H₆ gas to be introduced into a surface region layer was changed in such a manner that a local maximum value on the surface side would be larger than a local maximum value on the photoconductive layer side.

Table 11 shows the content and the local maximum value in that case.

Each of the produced photosensitive members was evaluated in the same manner as in Example 3.

Table 12 shows the evaluation results.

TABLE 10

| | | | Gradient-composition layer | | | Surface layer | | |
|---|---|---|---|---|---|---|---|---|
| | | | Local | | Local | Local | | Local |
| | | | maximum | Local | maximum | maximum | Local | maximum |
| | Lower | | value | maximum | value | value | maximum | value |
| | injection- | | pre- | value | post- | pre- | value | post- |
| | blocking | Photoconductive | forming | forming | forming | forming | forming | forming |
| Kind and flow rate of gas | layer | layer | region | region | region | region | region | region |
| SiH₄{mL/min(normal)} | 110 | 200 | 200→160 | 160→130 | 130→10 | 10 | 10 | 10 |
| H₂{mL/min(normal)} | 500 | 800 | 0 | 0 | 0 | 0 | 0 | 0 |
| B₂H₆{ppm} (with respect to | 0 | 0 | 0 | 90 | 0 | 5 | 150 | 0 |
| SiH₄) | | | | | | | | |
| N₂{mL/min(normal)} | 0 | 0 | 0→150 | 150→180 | 180→400 | 400 | 400 | 400 |
| CH₄{mL/min(normal)} | 400 | 0 | 0 | 0 | 0 | 0 | 0 | 0 |
| Substrate temperature {° C.} | 260 | 260 | 220 | 220 | 220 | 220 | 220 | 220 |
| Pressure in reaction vessel | 64 | 79 | 60 | 60 | 60 | 60 | 60 | 60 |
| {Pa} | | | | | | | | |
| High-frequency power {W} | 200 | 600 | 250 | 250 | 250 | 200 | 200 | 200 |
| 13.56 MHz | | | | | | | | |
| Thickness{μm} | 3 | 32 | 0.03 | 0.02 | 0.05 | 0.15 | 0.02 | 0.5 |

TABLE 11

| | Local maximum | Local maximum values | Minimum value | Interval between | |
|---|---|---|---|---|---|
| Photosensitive | values on | on photoconductive | between local | local maximum | N/(Si + N) |
| member | surface side | layer side | maximum values | values | atm % |
| Example 4-a | 4.4 × 10¹⁸ | 5.3 × 10¹⁸ | 1.3 × 10¹⁸ | 220 nm | 60 |
| Example 4-b | 4.4 × 10¹⁸ | 5.0 × 10¹⁸ | 1.3 × 10¹⁸ | 220 nm | 60 |
| Example 4-c | 4.4 × 10¹⁸ | 4.8 × 10¹⁸ | 1.3 × 10¹⁸ | 220 nm | 60 |
| Example 4-d | 4.0 × 10¹⁸ | 5.9 × 10¹⁸ | 2.6 × 10¹⁸ | 230 nm | 60 |
| Example 4-e | 4.0 × 10¹⁸ | 5.9 × 10¹⁸ | 2.5 × 10¹⁸ | 230 nm | 60 |
| Example 4-f | 4.0 × 10¹⁸ | 5.9 × 10¹⁸ | 2.4 × 10¹⁸ | 230 nm | 60 |
| Example 4-g | 4.0 × 10¹⁸ | 5.9 × 10¹⁸ | 0 | 230 nm | 60 |
| Example 5-a | 1.5 × 10¹⁹ | 5.5 × 10¹⁹ | 1.5 × 10¹⁷ | 80 nm | 60 |
| Example 5-b | 1.5 × 10¹⁹ | 5.5 × 10¹⁹ | 1.5 × 10¹⁷ | 100 nm | 60 |
| Example 5-c | 1.5 × 10¹⁹ | 5.5 × 10¹⁸ | 1.5 × 10¹⁷ | 120 nm | 60 |
| Example 5-d | 1.5 × 10¹⁹ | 5.5 × 10¹⁸ | 1.5 × 10¹⁷ | 960 nm | 60 |
| Example 5-e | 1.5 × 10¹⁹ | 5.5 × 10¹⁸ | 1.5 × 10¹⁷ | 1000 nm | 60 |
| Example 5-f | 1.5 × 10¹⁹ | 5.5 × 10¹⁸ | 1.5 × 10¹⁷ | 1200 nm | 60 |
| Example 6 | 7.2 × 10¹⁸ | 5.3 × 10¹⁸ | 1.7 × 10¹⁷ | 220 nm | 60 |

TABLE 12

| | | | | | Electric | | light- | |
|---|---|---|---|---|---|---|---|---|
| | | | Residual | | potential | Optical | transmitting | Cleaning |
| | Resolution | Chargeability | potential | Sensitivity | unevenness | memory | property | Property |
| Example 4-a | A | A | A | B | B | B | B | C |
| Example 4-b | A | A | A | B | B | B | B | C |
| Example 4-c | A | B | A | B | B | B | B | C |
| Example 4-d | B | A | A | B | B | B | B | C |
| Example 4-e | A | A | A | B | B | B | B | C |
| Example 4-f | A | A | A | B | B | B | B | C |
| Example 4-g | A | A | A | B | B | B | B | C |
| Example 5-a | C | C | C | B | B | B | B | C |
| Example 5-b | A | A | A | B | B | B | B | C |
| Example 5-c | A | A | A | B | B | B | B | C |
| Example 5-d | A | A | A | B | B | B | B | C |
| Example 5-e | A | A | A | B | B | B | B | C |
| Example 5-f | B | A | B | B | B | B | B | C |
| Example 6 | B | A | A | B | B | B | B | C |

The evaluation results of Example 4 in Table 12 show that when setting a local maximum value on the photoconductive layer side equal to or larger than 5.0×10¹⁸ atoms/cm³, chargeability is improved and that when setting a minimum value between local maximum values equal to or less than 2.5×10¹⁸ atoms/cm³, resolution is improved. When the minimum value between local maximum values is larger than 2.5×10¹⁸ atoms/cm³, the number of local maximum values is substantially equal to one, hence no effect of improving resolution is observed.

In addition, as can be seen from the results of Example 5, when the interval between local maximum values is less than 100 nm, the number of local maximum values is substantially equal to one, hence almost no effects of improving resolution, chargeability and residual potential are observed. Furthermore, when the interval is larger than 1,000 nm, effects of improving resolution, residual potential, and sensitivity are found to slightly reduce.

As can been seen from the results of Examples 3 and 6, particularly good resolution can be obtained when the local maximum value on the photoconductive layer side is set to be larger than the local maximum value on the surface side.

As can been seen from the foregoing, resolution can be improved by providing at least two local maximum values of the Group 13 element content, and electrical properties such as chargeability, residual potential, and sensitivity can be improved by setting the local maximum value on the photoconductive layer side equal to or larger than 5.0×10¹⁸ atoms/cm³ and setting the interval between local maximum values to fall within the range of 100 nm to 1,000 nm.

### EXAMPLE 7

In order to provide a layer constitution shown in FIG. 1B, a plasma CVD apparatus shown in FIG. 2 was used to superimpose deposition films composed of a lower injection-blocking layer, a photoconductive layer, a gradient-composition layer, and a surface layer in the stated order under the conditions shown in Table 13 on an aluminum cylinder (support), which had a diameter of 84 mm and a length of 381 mm and was subjected to mirror finish, to thereby produce an electrophotographic photosensitive member.

In this example, an NO gas and an SiF₄ gas were introduced during the formation of the surface layer through deposition in such a manner that an oxygen atom content and/or a fluorine atom content in the surface layer would have a local maximum value in the thickness direction of the surface layer.

Specifically, each photosensitive member was produced by changing the flow rate of each of an NO gas and an SiF₄ gas each diluted with a helium gas in a local maximum value forming region at a constant speed to provide a local maximum value of an oxygen atom content, a local maximum value of a fluorine atom content, and local maximum values of an oxygen atom content and a fluorine atom content.

In addition, the flow rate of B₂H₆ as a raw material for boron as a Group 13 element was changed to set the local maximum value of the Group 13 element content in the gradient-composition layer to be 7.5.×10¹⁸ atoms/cm³, the local maximum value of the Group 13 element content in the surface layer to be 4.0×10¹⁸ atoms/cm³, and a minimum value of the Group 13 element content present between the local maximum value of the gradient-composition layer and the local maximum value of the surface layer to be 1.5×10¹⁷ atoms/cm³.

Furthermore, the distance between two local maximum values of the Group 13 element content to be distributed in the gradient-composition layer and the surface layer was 300 nm.

Each of the produced photosensitive members was evaluated in the same manner as in Example 3.

Table 14 shows the evaluation results.

TABLE 13

| | | | Gradient-composition layer | | | Surface layer | | |
|---|---|---|---|---|---|---|---|---|
| | | | Local | | Local | Local | | Local |
| | | | maximum | Local | maximum | maximum | Local | maximum |
| | Lower | | value | maximum | value | value | maximum | value |
| | injection- | | pre- | value | post- | pre- | value | post- |
| | blocking | Photoconductive | forming | forming | forming | forming | forming | forming |
| Kind and flow rate of gas | layer | layer | region | region | region | region | region | region |
| SiH₄{mL/min(normal)} | 110 | 200 | 200→160 | 160→130 | 130→25 | 25 | 25 | 25 |
| H₂{mL/min(normal)} | 500 | 800 | 0 | 0 | 0 | 0 | 0 | 0 |
| B₂H₆{ppm} (with respect to | 0 | 0 | 0 | 700 | 0 | 0.2 | 150 | 0 |
| SiH₄) | | | | | | | | |
| N₂{mL/min(normal)} | 8 | 0 | 0 | 0 | 0 | 0 | 0 or 1 | 0 |
| CH₄[mL/min(normal)] | 0 | 0 | 0→150 | 150→180 | 180→500 | 500 | 500 | 500 |
| Substrate temperature {° C.} | 0 | 0 | 0 | 0 | 0 | 0 | 0 or 5 | 0 |
| Pressure in reaction vessel | | | | | | | | |
| {Pa} | | | | | | | | |
| High-frequency power {W} | 260 | 260 | 220 | 220 | 220 | 220 | 220 | 220 |
| 13.56 MHz | | | | | | | | |
| {μm} | 64 | 79 | 60 | 60 | 60 | 60 | 60 | 60 |
| High-frequency power | 200 | 600 | 250 | 250 | 250 | 200 | 200 | 200 |
| {W} 13.56 MHz | | | | | | | | |
| Thickness{μm} | 3 | 32 | 0.08 | 0.2 | 0.08 | 0.15 | 0.05 | 0.5 |

TABLE 14

| | Local | Local | | | | | | | |
|---|---|---|---|---|---|---|---|---|---|
| | maximum | maximum | | | | | Electric | | |
| | value of | value of | | | Residual | | potential | Optical | Cleaning |
| | oxygen | fluorine | Resolution | Chargeability | potential | Sensitivity | unevenness | memory | property |
| Example 7-a | Present | Absent | A | A | A | B | B | B | A |
| Example 7-b | Absent | Present | A | A | A | B | B | B | A |
| Example 7-c | Present | Present | A | A | A | B | B | B | A |

Table 14 shows that when providing a surface layer with a local maximum value of an oxygen atom and/or a fluorine atom, cleaning properties are improved.

### EXAMPLE 8

A plasma CVD apparatus shown in FIG. 2 was used to sequentially superimpose deposition films under the conditions shown in Table 15 on an aluminum cylinder (support), which had a diameter of 84 mm and a length of 381 mm and was subjected to mirror finish, to thereby produce a photosensitive member composed of a lower injection-blocking layer, a photoconductive layer, and a surface region layer (a TBL-1, an intermediate layer, a TBL-2, a surface protective layer). As shown in Table 15, the flow rates of an N₂ gas and a B₂H₆ gas were changed during the formation of the surface region layer. A method of introducing a gas in the formation of a local maximum value shown in Table 15 involved: increasing the amount of each of an N₂ gas and a B₂H₆ gas from a certain value to a value shown in Table 15 in a linear fashion over a predetermined time period; and reducing the amount to the initial certain value in a linear fashion again at the same rate as the rate at which the amount was increased.

Furthermore, the amount of each of an NO gas and an SiF₄ gas to be introduced was changed to provide a local maximum value.

TABLE 15

| | Lower | | Surface region layer | | | |
|---|---|---|---|---|---|---|
| | injection- | | | | | Surface |
| | blocking | Photoconductive | | Intermediate | | protective |
| Kind and flow rate of gas | layer | layer | TBL-1 | layer | TBL-2 | layer |
| SiH₄[mL/min(normal)] | 170 | 170 | 10 | 30 | 10 | 30 |
| H₂[mL/min(normal)] | 600 | 900 | — | — | — | — |
| B₂H₆[ppm(with respect to SiH₄)] | — | — | 0→1000→0 | — | 0→500→0 | — |
| N₂[mL/min(normal)] | — | — | 0→300 | 300→500→300 | 300 | 300→500 |
| NO[% or ppm(with respect to | 600 | — | — | — | — | — |
| SiH₄)] | | | | | | |
| CH₄[mL/min(normal)] | 5% | — | — | 0→10 | — | — |
| | | | | ppm→0 | | |
| SiF₄[mL/min(normal)] | — | — | — | 2 | — | — |
| Support temperature [° C.] | 270 | 260 | 260 | 260 | 260 | 260 |
| Pressure[Pa] | 80 | 75 | 52 | 50 | 52 | 50 |
| RF power[W] | 200 | 40 | 200 | 300 | 200 | 300 |
| Thickness[μm] | 2.5 | 30 | 0.1 | 0.2 | 0.1 | 0.6 |

The surface region layer of the produced photosensitive member was subjected to SIMS measurement in the same manner as in Example 1. As a result, it was found that the nitrogen atom content and the boron atom content had distributions shown in FIG. 11B. Furthermore, the boron atom contents at local maximum values of the surface region layer obtained by changing the amount of each of an NO gas and an SiF₄ gas to be introduced were 8.0×10¹⁸ atoms/cm³ and 4.0×10¹⁸ atoms/cm³ from the photoconductive layer side, the interval between the local maximum values of the boron atom content was 300 nm, and the interval between the local maximum value and minimum value of the nitrogen atom content was 150 nm. In addition, the local maximum value of the nitrogen atom content represented by N/(Si+N) was 55 atm %.

The produced photosensitive member was set in the iRC 6800-405 nm reconstructed machine, and was then evaluated for the respective items ranging from (1) resolution to (8) cleaning properties in the same manner as in Example 3. In this example, the photosensitive member was evaluated for the following item (9) image defect, provided that the photosensitive member was evaluated for the respective items (1) to (9) with a photosensitive member of Comparative Example 2 as a reference. Table 20 shows the evaluation results.

(9) Image Defect

Image defects were evaluated on the basis of the number of white spots each having a diameter of 0.1 mm or less in an image having a pixel density of 100% and the number of black spots each having a diameter of 0.1 mm or less in an image having a pixel density of 0%. In most cases, dust or the like adhering to a support before the initiation of film formation of a photosensitive member is responsible for white and black spots each having a diameter in excess of 0.1 mm. As a result of various studies made by the inventors of the present invention, it has been found that the occurrence of such image defects is not ascribable to conditions for film formation in most cases,and it is essential to eliminate image defects through an improvement in process such as a reduction, in dust. Therefore, such spots were excluded from an object to be evaluated in this case, and evaluation was performed while focusing on the amount of relatively small image defects each having a diameter of 0.1 mm or less which would be dependent on conditions for film formation. The evaluation was performed by ranking the photosensitive members through relative evaluation with the value for a photosensitive member having such a layer constitution as shown in Comparative Example 2 to be described later as a reference (100%).
A: An extremely good level at which a value is less than 60% of the reference.
B: A good level at which a value is 60% or more and less than 90% of the reference.
C: A level at which a value is comparable to the reference.

### COMPARATIVE EXAMPLE 2

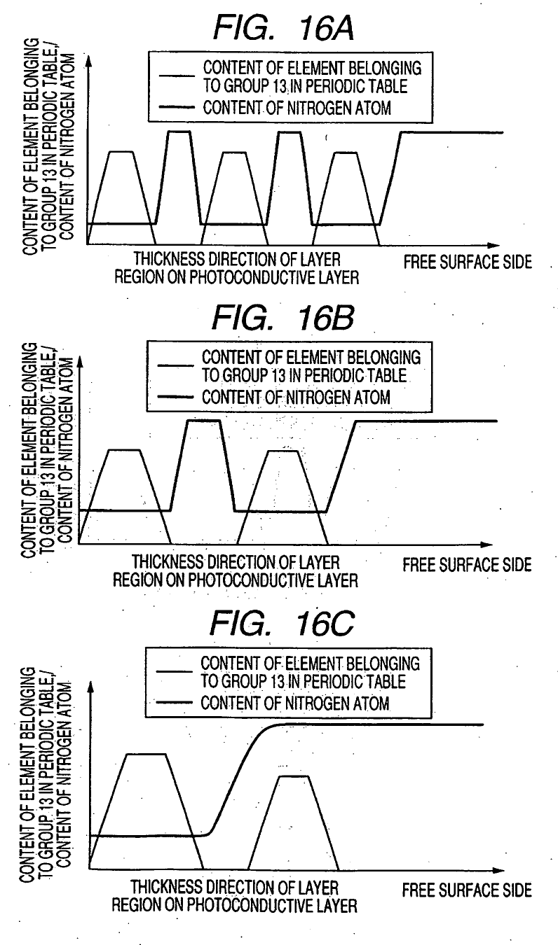

In the same manner as in Example 8, deposition films were sequentially superimposed under the conditions shown in Table 4 to produce a photosensitive member composed of a lower injection-blocking layer, a photoconductive layer, a upper injection-blocking layer, and a surface layer. The produced photosensitive member was subjected to SIMS measurement in the same manner as in Example 8. As a result, distributions shown in FIG. 16C were obtained. The local maximum value of the boron atom content was 8.0×10₁₈ atoms/cm³. In addition, the local maximum value of the nitrogen atom content represented by N/(Si+N) was 57 atm %.

The produced photosensitive member was evaluated for properties in the same manner as in Example 8. Table 18 shows the results.

TABLE 16

| | Lower | | Upper | |
|---|---|---|---|---|
| | injection- | Photo- | injection- | |
| Kind and flow rate of | blocking | conductive | blocking | Surface |
| gas | layer | layer | layer | layer |
| SiH₄[mL/min(normal)] | 170 | 170 | 10 | 30 |
| H₂[mL/min(normal)] | 600 | 1000 | — | — |
| B₂H₆[ppm(with respect to | — | — | 1000 | — |
| SiH₄)] | | | | |
| N₂[mL/min(normal)] | — | — | 300 | 500 |
| CH₄[mL/min(normal)] | 600 | — | — | — |
| NO[% or ppm(with | 5% | — | — | — |
| respect to SiH₄)] | | | | |
| Support temperature | 270 | 260 | 220 | 220 |
| [° C.] | | | | |
| Pressure[Pa] | 80 | 75 | 60 | 56 |
| RF power[W] | 200 | 40 | 200 | 180 |
| Thickness[μm] | 2.5 | 30 | 0.1 | 0.6 |

### EXAMPLE 9

In the same manner as in Example 8, deposition films were sequentially superimposed under the conditions shown in Table 17 to produce a photosensitive member composed of a lower injection-blocking layer, a photoconductive layer, and a surface region layer. In this case, the photosensitive member was produced in the same manner as in Example 8 except that neither an NO gas nor an SiF₄ gas was used for the surface region layer (a TBL-1, an intermediate layer, a TBL-2, and a surface protective layer). The surface region layer of the produced photosensitive member was subjected to SIMS measurement in the same manner as in Example 1. As a result, it was found that the nitrogen atom content and the boron atom content had distributions shown in FIG. 11B. Local maximum values of the boron atom content were 8.0×10¹⁸ atoms/cm³ and 4.0×10¹⁸ atoms/cm³ from the photoconductive layer side, the interval between the local maximum values of the boron atom content was 200 nm, and the interval between the local maximum value and minimum value of the nitrogen atom content was 100 nm. In addition, the local maximum value of the nitrogen atom content represented by N/(Si+N) was 65 atm %.

The produced photosensitive member was evaluated for properties in the same manner as in Example 8. Table 18 shows the results.

TABLE 17

| | Lower | | Surface region layer | | | |
|---|---|---|---|---|---|---|
| | injection- | | | | | Surface |
| | blocking | Photoconductive | | Intermediate | | protective |
| Kind and flow rate of gas | layer | layer | TBL-1 | layer | TBL-2 | layer |
| SiH₄[mL/min(normal)] | 170 | 170 | 40 | 30 | 40 | 30 |
| H₂[mL/min(normal)] | 600 | 1000 | — | — | — | — |
| B₂H₆[ppm(with respect to SiH₄)] | — | — | 0→1000→0 | — | 0→500→0 | — |
| N₂[mL/min(normal)] | — | — | 0→500 | 500→800→500 | 500 | 500→800 |
| CH₄[mL/min(normal)] | 300 | — | — | — | — | — |
| NO[% or ppm(with respect to | 6% | — | — | — | — | — |
| SiH₄)] | | | | | | |
| Support temperature [° C.] | 270 | 260 | 260 | 260 | 260 | 260 |
| Pressure[Pa] | 80 | 75 | 52 | 50 | 52 | 50 |
| RF power[W] | 200 | 40 | 180 | 200 | 180 | 200 |
| Thickness[μm] | 2.5 | 30 | 0.1 | 0.1 | 0.1 | 0.8 |

TABLE 18

| | | | | | Electric | | light- | | |
|---|---|---|---|---|---|---|---|---|---|
| Photosensitive | | | Residual | | potential | Optical | transmitting | | Image |
| member | Resolution | Chargeability | potential | Sensitivity | unevenness | memory | property | CLN | defect |
| Comparative | C | C | C | C | C | C | C | C | C |
| Example 2 | | | | | | | | | |
| Example 8 | A | A | A | A | B | A | A | A | A |
| Example 9 | B | A | B | A | B | B | A | B | A |

As is apparent from the above results, the resolution of an image of 1,200 dpi increased with blue light-emitting semiconductor laser light (405 nm). Accordingly, it has been revealed that dot reproducibility can be enhanced by using a surface region layer as with Example 8 having two local maximum values of each of the boron atom content and the nitrogen atom content in the surface region layer and local maximum values of the oxygen atom content and the fluorine atom content, and the original effect to be exhibited by reducing a spot diameter is sufficiently exerted. It has been also found that a photosensitive member having the surface region layer in Example 8 has excellent photoconductive properties.

Furthermore, it has been found that when providing local maximum values of an oxygen atom content and a fluorine atom content, resolution, reduction in residual potential, reduction in optical memory and cleaning properties can be further improved.

### EXAMPLE 10

In the same manner as in Example 8, deposition films were sequentially superimposed under the conditions shown in Table 19 to produce a photosensitive member composed of a lower injection-blocking layer, a photoconductive layer, and a surface region layer (a TBL-1, an intermediate layer, a TBL-2, and a surface protective layer). Six kinds of photosensitive members 8I to 8N were produced in the same manner as in Example 8 except that the flow rate of a B₂H₆ gas to be introduced into a surface region layer was changed. The produced photosensitive members each were subjected to SIMS measurement. As a result, it was found that the nitrogen atom content and the boron atom content had distributions shown in FIG. 9A or 9B. As shown in Table 20, local maximum values of the boron atom content were 4.5 to 5.5×10¹⁸ atoms/cm³ and 2.4×10¹⁹ atoms/cm³ from a photoconductive layer side, and the local maximum value of the nitrogen atom content represented by N/(Si+N) was 50 atm %. In addition, the interval between the local maximum values of the boron atom content was 350 nm, and the interval between the local maximum value and the minimum value of the nitrogen atom content was 175 nm.

The produced photosensitive members were evaluated for properties in the same manner as in Example 8. Table 21 shows the results.

TABLE 19

| | | | Surface region layer | | | |
|---|---|---|---|---|---|---|
| | Lower | | | | | Surface |
| | injection- | Photoconductive | | Intermediate | | protective |
| Kind and flow rate of gas | blocking layer | layer | TBL-1 | layer | TBL-2 | layer |
| SiH₄[mL/min(normal)] | 150 | 200 | 100 | 50 | 100 | 50 |
| H₂[mL/min(normal)] | 600 | 1200 | — | — | — | — |
| B₂H₆[ppm(with respect to SiH₄)] | — | — | 0→*1→*2 | *2 | *2→3000→0 | — |
| N₂[mL/min(normal)] | — | — | 0→800 | 1000 | 1000→800 | 1000→800 |
| CH₄[mL/min(normal)] | 500 | — | — | — | — | — |
| NO[% or ppm(with respect to | 8% | — | — | — | 0→100 | — |
| SiH₄)] | | | | | ppm→0 | |
| SiF₄[mL/min(normal)] | — | — | — | — | 10 | — |
| Support temperature [° C.] | 270 | 260 | 260 | 260 | 260 | 260 |
| Pressure[Pa] | 150 | 500 | 52 | 50 | 52 | 50 |
| RF power[W] | 2 | 30 | 250 | 200 | 250 | 200 |
| Thickness[μm] | 2.5 | 30 | 0.15 | 0.2 | 0.15 | 0.6 |

*1: 600 to 700,
*2: 100 to 300

TABLE 20

| | Local maximum | | |
|---|---|---|---|
| | value of boron | Minimum value | |
| | atom content on | between local | |
| Photo- | photoconductive | maximum values of | Correspondence |
| sensitive | layer side | boron atom content | with peak |
| member | (×10¹⁸ atoms/cm³) | (×10¹⁸ atoms/cm³) | diagram |
| 10-I | 5.5 | 2.0 | |
| 10-J | 5.0 | 2.0 | |
| 10-K | 4.5 | 2.0 | |
| 10-L | 5.5 | 2.5 | |
| 10-M | 5.5 | 3.0 | |
| 10-N | 5.5 | 3.0 | |

TABLE 21

| | | | | | Electric | | light- | | |
|---|---|---|---|---|---|---|---|---|---|
| Photosensitive | | | Residual | | potential | Optical | transmitting | | Image |
| member | Resolution | Chargeability | potential | Sensitivity | unevenness | memory | property | CLN | defect |
| 10-I | B | A | A | A | B | A | A | A | A |
| 10-J | B | A | A | A | B | A | A | A | A |
| 10-K | C | C | A | A | B | A | A | A | A |
| 10-L | C | B | A | A | B | A | A | A | A |
| 10-M | C | C | A | A | B | A | A | A | A |
| 10-N | B | A | A | A | B | A | A | A | A |

As is apparent from the above results, when the local maximum value of the Group 13 element content closest to the photoconductive layer side is 5.0×10¹⁸ atoms/cm³ or more, the resolution and chargeability are additionally improved. When the minimum value of the Group 13 element content present between two adjacent local maximum values of the Group 13 element content is 2.5×10¹⁸ atoms/cm³ or less, an additional improvement in chargeability is observed. In addition, it has been found that the same effects on photoconductive properties as in the case where the Group 13 element is incorporated as a local maximum value can be obtained even when the element is incorporated as a local maximum region.

### EXAMPLE 11

In the same manner as in Example 8, deposition films were sequentially superimposed under the conditions shown in Table 22 with the flow rate of a B₂H₆ gas to be introduced into a surface region layer changed from that in Example 8, to thereby produce a photosensitive member composed of a lower injection-blocking layer, a photoconductive layer, and the surface region layer (a TBL-1, an intermediate layer, a TBL-2, and a surface protective layer).

The photosensitive member was produced in the same manner as in Example 8 except that the flow rate of the B₂H₆ gas to be introduced into the surface region layer was changed. The produced photosensitive member was subjected to SIMS measurement in the same manner as in Example 1. As a result, it was found that the nitrogen atom content and the boron atom content each had a distribution in which a local maximum value on the free surface side of two local maximum values of the Group 13 element content as shown in FIG. 11A was larger. Local maximum values of the boron atom content were 5.1×10¹⁸ atoms/cm³ and 6.4×10¹⁸ atoms/cm³ from the photoconductive layer side, the interval between the local maximum values of the boron atom content was 180 nm, and the interval between the local maximum value and minimum value of the nitrogen atom content was 90 nm. The local maximum value of the nitrogen atom content represented by N/(Si+N) was 50 atm %.

The produced photosensitive member was evaluated for properties in the same manner as in Example 8. Table 23 shows the results.

TABLE 22

| | | | Surface region layer | | | |
|---|---|---|---|---|---|---|
| | Lower | | | | | Surface |
| | injection- | Photoconductive | | Intermediate | | protective |
| Kind and flow rate of gas | blocking layer | layer | TBL-1 | layer | TBL-2 | layer |
| SiH₄[mL/min(normal)] | 150 | 200 | 20 | 50 | 20 | 50 |
| H₂[mL/min(normal)] | 600 | 1200 | — | — | — | — |
| B₂H₆[ppm(with respect to SiH₄)] | — | — | 0→600→0 | — | 0→800→0 | — |
| N₂[mL/min(normal)] | — | — | 0→300 | 300→1000→300 | 300 | 300→1200 |
| CH₄[mL/min(normal)] | 450 | — | — | — | — | — |
| NO[% or ppm(with respect to | 8% | — | — | — | 0→100 | — |
| SiH₄)] | | | | | ppm→0 | |
| SiF₄[mL/min(normal)] | 270 | 260 | — | — | 4 | — |
| Support temperature [° C.] | 75 | 78 | 260 | 260 | 260 | 260 |
| Pressure[Pa] | 150 | 500 | 52 | 50 | 52 | 50 |
| RF power[W] | 2 | 30 | 180 | 200 | 180 | 200 |
| Thickness[μm] | 2.5 | 30 | 0.08 | 0.1 | 0.08 | 0.6 |

TABLE 23

| | | | | | Electric | | light- | | |
|---|---|---|---|---|---|---|---|---|---|
| Photosensitive | | | Residual | | potential | Optical | transmitting | | Image |
| member | Resolution | Chargeability | potential | Sensitivity | unevenness | memory | property | CLN | defect |
| Example 11 | C | C | C | B | B | A | A | A | A |

As is apparent from the above results, the improvements of properties in terms of sensitivity, reduction in electric potential unevenness, reduction in optical memory, light-transmitting property, and reduction in image defects were observed by providing the surface region layer with two local maximum values of each of the boron atom content and the nitrogen atom content and with local maximum values of the oxygen atom content and the fluorine atom content. However, no improvements of properties in terms of resolution, chargeability, and reduction in residual potential were observed in Example 11 in which an Group 13 element in the periodic table was incorporated in such a manner that a local maximum value on the free surface side of two local maximum values of the Group 13 element content in the surface region layer would be larger.

### EXAMPLE 12

In the same manner as in Example 8, deposition films were sequentially superimposed under the conditions shown in Table 24 with the flow rate of a B₂H₆ gas to be introduced into a surface region layer and a film forming time period changed from those of Example 8 and with the distance between two local maximum values of the Group 13 element content in a surface region layer (a TBL-1, an intermediate layer, a TBL-2, and a surface protective layer) changed, to thereby produce five kinds of photosensitive members each composed of a lower injection-blocking layer, a photoconductive layer, and a surface region layer. The produced photosensitive members each were subjected to SIMS measurement. As a result, it was found that the nitrogen atom content and the boron atom content had distributions shown in FIG. 10. Local maximum values of the boron atom content were 6.2×10¹⁸ atoms/cm³ and 6.2×10¹⁸ atoms/cm³ from the photoconductive layer side. The interval between the local maximum values of the boron atom content was 80 to 1070 nm as shown in Table 25, and the interval between the local maximum value of the nitrogen atom content represented by N/(Si+N) was 50 atm %.

The produced photosensitive member was evaluated for properties in the same manner as in Example 8. Table 26 shows the results.

TABLE 24

| | | | Surface region layer | | | |
|---|---|---|---|---|---|---|
| | Lower | | | | | Surface |
| | injection- | Photoconductive | | Intermediate | | protective |
| Kind and flow rate of gas | blocking layer | layer | TBL-1 | layer | TBL-2 | layer |
| SiH₄[mL/min(normal)] | 150 | 200 | 20 | 50 | 20 | 50 |
| H₂[mL/min(normal)] | 600 | 1200 | — | — | — | — |
| B₂H₆[ppm(with respect to SiH₄)] | — | — | 0→700→0 | — | 0→700→0 | — |
| N₂[mL/min(normal)] | — | — | 0→500 | 500→1000→500 | 500 | 500→1000 |
| CH₄[mL/min(normal)] | — | — | — | — | — | — |
| NO[% or ppm(with respect to | 6% | — | — | — | 0→20 | — |
| SiH₄)] | | | | | ppm→0 | |
| SiF₄[mL/min(normal)] | 270 | 260 | — | — | 4 | — |
| Support temperature [° C.] | 75 | 78 | 260 | 260 | 260 | 260 |
| Pressure[Pa] | 150 | 500 | 52 | 50 | 52 | 50 |
| RF power[W] | 2 | 30 | 180 | 200 | 180 | 200 |
| Thickness[μm] | 2.5 | 30 | 0.07 | *3 | 0.07 | 0.6 |

*3: 0.01 to 1.00

TABLE 25

| | Photosensitive member | | | | |
|---|---|---|---|---|---|
| | 12-O | 12-P | 12-Q | 12-R | 12-S |
| Distance between local maximum | 80 | 100 | 500 | 1000 | 1070 |
| values of Group 13 element | | | | | |
| content (nm) | | | | | |

TABLE 26

| | | | | | Electric | | light- | | |
|---|---|---|---|---|---|---|---|---|---|
| Photosensitive | | | Residual | | potential | Optical | transmitting | | Image |
| member | Resolution | Chargeability | potential | Sensitivity | unevenness | memory | property | CLN | defect |
| 12-O | C | C | C | B | B | A | A | A | A |
| 12-P | A | A | A | A | B | A | A | A | A |
| 12-Q | A | A | A | A | B | A | A | A | A |
| 12-R | A | A | A | A | B | A | A | A | A |
| 12-S | B | C | B | B | B | A | A | A | A |

As is apparent from the above results, the distance between two local maximum values of the Group 13 element content present in the surface region layer is more preferably in the range of 100 nm to 1,000 nm in the thickness direction of the layer in terms of resolution, chargeability, reduction in residual potential, and sensitivity.

### EXAMPLE 13

In the same manner as in Example 8, deposition films were sequentially superimposed under the conditions shown in Table 27 with the flow rate of an N₄ gas to be introduced into a surface region layer changed and with the ratio of a local maximum value of the nitrogen atom content in a surface region layer to the minimum value thereof (local maximum value/minimum value) changed, to thereby produce four kinds of photosensitive members (13T to 13W) each composed of a lower injection-blocking layer, a photoconductive layer, and a surface region layer (a TBL-1, an intermediate layer, a TBL-2, and a surface protective layer). The produced photosensitive member was subjected to SIMS measurement. As a result, it was found that the nitrogen atom content and the boron atom content had distributions shown in FIG. 12. The local maximum values of the boron atom content were 8.0×10¹⁸ atoms/cm³ and 8.0×10¹⁸ atoms/cm³ from the photoconductive layer side. The interval between the maximum values of the boron atom content was 170 nm, and the interval between the local maximum value and minimum value of the nitrogen atom content was 85 nm. In addition, the local maximum value of the nitrogen atom content represented by N/(Si+N) was 43 to 67 atm %. The local minimum value with respect to the local maximum value of the nitrogen atom content is shown in Table 28.

The produced photosensitive member was evaluated for properties in the same manner as in Example 8. Table 29 shows the results.

TABLE 27

| | | | Surface region layer | | | |
|---|---|---|---|---|---|---|
| | Lower | | | | | Surface |
| | injection- | Photoconductive | | Intermediate | | protective |
| Kind and flow rate of gas | blocking layer | layer | TBL-1 | layer | TBL-2 | layer |
| SiH₄[mL/min(normal)] | 100 | 200 | 20 | 50 | 20 | 50 |
| H₂[mL/min(normal)] | 580 | 900 | — | — | — | — |
| B₂H₆[ppm(with respect to SiH₄)] | — | — | 1000 | 0 | 1000 | — |
| N₂[mL/min(normal)] | — | — | *4 | *5 | *4 | *5 |
| CH₄[mL/min(normal)] | 800 | — | — | — | — | — |
| NO[% or ppm(with respect to | 6% | — | — | — | 0→ | — |
| SiH₄)] | | | | | 100 ppm→0 | |
| SiF₄[mL/min(normal)] | 270 | 260 | — | — | 6 | — |
| Support temperature [° C.] | 75 | 78 | 260 | 260 | 260 | 260 |
| Pressure[Pa] | 150 | 500 | 52 | 50 | 52 | 50 |
| RF power[W] | 2 | 30 | 180 | 200 | 180 | 200 |
| Thickness[μm] | 2.5 | 30 | 0.07 | 0.01 | 0.07 | 0.6 |

*4: 100 to 500,
*5: 600 to 800

TABLE 28

| | Photosensitive member | | | |
|---|---|---|---|---|
| | 13-T | 13-U | 13-V | 13-W |
| Local maximum value of minimum value of | 105 | 110 | 120 | 130 |
| nitrogen atom content (%) | | | | |

TABLE 29

| | | | | | Electric | | light- | | |
|---|---|---|---|---|---|---|---|---|---|
| Photosensitive | | | Residual | | potential | Optical | transmitting | | Image |
| member | Resolution | Chargeability | potential | Sensitivity | unevenness | memory | property | CLN | defect |
| 13-T | A | A | A | A | B | A | A | A | C |
| 13-U | A | A | A | A | B | A | A | A | A |
| 13-V | A | A | A | A | B | A | A | A | A |
| 13-W | A | A | A | A | B | A | A | A | A |

As is apparent from the above results, the rate of the local maximum value to the minimum value of the nitrogen atom content in the surface region layer is more preferably 110% or more from the viewpoint of reducing image defects.

### EXAMPLE 14

Deposition films were sequentially superimposed under the conditions shown in Table 30 in the same manner as in Example 8 except that a time period for forming a second upper injection-blocking layer (TBL-1) was changed from that of Example 8, with the distance between the minimum value between two local maximum values of the nitrogen atom content in a surface region layer and the local maximum value on the photoconductive layer side out of the two local maximum values of the nitrogen atom content changed, to thereby produce photosensitive members (14X to 14AC) each composed of a lower injection-blocking layer, a photoconductive layer, and a surface region layer (a TBL-1, an intermediate layer, a TBL-2, and a surface protective layer).

The photosensitive member was produced in the same manner as in Example 2 except that a time period for forming the second upper injection-blocking layer (TBL-1) was changed. The produced photosensitive member was subjected to SIMS measurement. As a result, it was found that the nitrogen atom content and the boron atom content each had peaks. Local maximum values of the boron atom content were 8.0×10¹⁸ atoms/cm³ and 8.0 ×10¹⁸ atoms/cm³ from the photoconductive layer side. As shown in Table 31, the interval between the local maximum value and minimum value of the nitrogen atom content was 30 to 310 nm. The local maximum value of the nitrogen atom content represented by N/(Si+N) was 38 atm %.

The produced photosensitive member was evaluated for properties in the same manner as in Example 2. Table 32 shows the results.

TABLE 30

| | | | Surface region layer | | | |
|---|---|---|---|---|---|---|
| | Lower | | | | | Surface |
| | injection- | Photoconductive | | Intermediate | | protective |
| Kind and flow rate of gas | blocking layer | layer | TBL-1 | layer | TBL-2 | layer |
| SiH₄[mL/min(normal)] | 170 | 170 | 20 | 50 | 20 | 50 |
| H₂[mL/min(normal)] | 600 | 1000 | — | — | — | — |
| B₂H₆[ppm(with respect to SiH₄)] | — | — | 1000 | — | 1000 | — |
| N₂[mL/min(normal)] | — | — | 400 | 600 | 400 | 600 |
| CH₄[mL/min(normal)] | 300 | — | — | — | — | — |
| NO[% or ppm(with respect to | 5% | — | — | — | 10 | — |
| SiH₄)] | | | | | | |
| SiF₄[mL/min(normal)] | — | — | — | — | 15 | — |
| Support temperature [° C.] | 270 | 260 | 220 | 220 | 220 | 220 |
| Pressure[Pa] | 80 | 75 | 60 | 56 | 60 | 56 |
| RF power[W] | 200 | 400 | 180 | 180 | 180 | 180 |
| Thickness[μm] | 2.5 | 30 | 0.08 | * | * | 0.7 |

*: A film forming time period was adjusted to change the thickness of each layer in such a manner that the total thickness of an intermediate layer and a TBL-2 would fall within the range of 0.06 to 0.62.

TABLE 31

| | Photosensitive member | | | | | |
|---|---|---|---|---|---|---|
| | 14X | 14Y | 14Z | 14AA | 14AB | 14AC |
| Distance between local | 30 | 40 | 50 | 100 | 300 | 310 |
| maximum value and | | | | | | |
| minimum value of nitrogen | | | | | | |
| atom content (nm) | | | | | | |

TABLE 32

| | | | | | Electric | | light- | | |
|---|---|---|---|---|---|---|---|---|---|
| Photosensitive | | | Residual | | potential | Optical | transmitting | | Image |
| member | Resolution | Chargeabililty | potential | Sensitivity | unevenness | memory | property | CLN | defect |
| 14-X | A | A | A | A | B | A | A | A | B |
| 14-Y | A | A | A | A | B | A | A | A | A |
| 14-Z | A | A | A | A | B | A | A | A | A |
| 14-AA | A | A | A | A | B | A | A | A | A |
| 14-AB | A | A | A | A | B | A | A | A | A |
| 14-AC | A | A | A | A | B | A | A | A | B |

As is apparent from the above results, the distance between the minimum value between two local maximum values of the content of nitrogen atoms in the surface region layer and the local maximum value on the photoconductive layer side is more preferably in the range of 40 nm to 300 nm (both inclusive) in the thickness direction of the layer in terms of reduction in image defects.

### EXAMPLE 15

Deposition films were sequentially superimposed under the conditions shown in Table 33 in the same manner as in Example 8 except that a Group 13 element in the periodic table was incorporated into the entirety of the surface region layer, to thereby produce a photosensitive member composed of a lower injection-blocking layer, a photoconductive layer, and a surface region layer (a TBL-1, an intermediate layer, a TBL-2, and a surface protective layer) under the condition shown in Table 33. The produced photosensitive member was subjected to SIMS measurement. As a result, it was found that the nitrogen atom content and the boron atom content had distributions shown in FIG. 13. The local maximum values of the boron atom content were 8.0×10¹⁸ atoms/cm³ and 8.0×10¹⁸ atoms/cm³ from the photoconductive layer side. The interval between the local maximum values of the boron atom content was 300 nm, and the interval between the local maximum value and minimum value of the nitrogen atom content was 150 nm. The local maximum value of the nitrogen atom content represented by N/(Si+N) was 39 atm %.

The produced photosensitive member was evaluated for properties in the same manner as in Example 8. Table 34 shows the results.

TABLE 33

| | | | Surface region layer | | | |
|---|---|---|---|---|---|---|
| | Lower | | | | | Surface |
| | injection- | Photoconductive | | Intermediate | | protective |
| Kind of flow rate of gas | blocking layer | layer | TBL-1 | layer | TBL-2 | layer |
| SiH₄[mL/min(normal)] | 150 | 200 | 20 | 50 | 20 | 50 |
| H₂[mL/min(normal)] | 580 | 1100 | — | — | — | — |
| B₂H₆[ppm(with respect to SiH₄)] | — | — | 0→1000 →0 | 400 | 400→1000 | 400 |
| | | | | | →400 | |
| N₂[mL/min(normal)] | — | — | 0→400 | 400→ | 400 | 400→600 |
| | | | | 600→ | | |
| | | | | 400 | | |
| CH₄[mL/min(normal)] | 500 | — | — | — | — | — |
| NO[% or ppm(with respect to | 2% | — | — | — | 0→ | — |
| SiH₄)] | | | | | 10 ppm→0 | |
| SiF₄[mL/min(normal)] | 270 | 260 | — | — | 5 | — |
| Support temperature [° C.] | 75 | 78 | 260 | 260 | 260 | 260 |
| Pressure[Pa] | 150 | 500 | 52 | 50 | 52 | 50 |
| RF power[W] | 2 | 30 | 180 | 200 | 180 | 200 |
| Thickness[μm] | 2.5 | 30 | 0.1 | 0.2 | 0.1 | 0.6 |

TABLE 34

| | | | | | Electric | | light- | | |
|---|---|---|---|---|---|---|---|---|---|
| Photosensitive | | | Residual | | potential | Optical | transmitting | | Image |
| member | Resolution | Chargeability | potential | Sensitivity | unevenness | memory | property | CLN | defect |
| Example 15 | A | A | A | A | B | A | A | A | A |

As is apparent from the above results, in all the items, the evaluated properties are improved even when the Group 13 element content has two local maximum values on the condition that the Group 13 element is incorporated into the entirety of the surface region layer.

### EXAMPLE 16

In the same manner as in Example 8, deposition films were sequentially superimposed under the conditions shown in Table 35 with the flow rate of a B₂H₆ gas and the flow rate of an N₂ gas changed from those of Example 8 in such a manner that the Group 13 element content and the nitrogen atom content in a surface region layer would have local maximum values at an identical phase, to thereby produce a photosensitive member composed of a lower injection-blocking layer, a photoconductive layer, and a surface region layer (a TBL-1, an intermediate layer, a TBL-2, and a surface protective layer). The produced photosensitive member was subjected to SIMS measurement. As a result, it was found that the nitrogen atom content and the boron atom content had such distributions as shown in FIG. 8. The local maximum values of the boron atom content were 5.1×10¹⁸ atoms/cm³ and 5.1×10¹⁸ atoms/cm₃ from the photoconductive layer side. The interval between the local maximum values of the boron atom content was 500 nm. The interval between the local maximum value and minimum value of the nitrogen atom content was 150 nm. The local maximum value of the nitrogen atom content represented by N/(Si+N) was 39 atm %

The produced photosensitive member was evaluated for properties in the same manner as in Example 8. Table 36 shows the results.

TABLE 35

| | | | Surface region layer | | | |
|---|---|---|---|---|---|---|
| | Lower | | | | | Surface |
| | injection- | Photoconductive | | Intermediate | | protective |
| Kind of flow rate of gas | blocking layer | layer | TBL-1 | layer | TBL-2 | layer |
| SiH₄[mL/min(normal)] | 150 | 200 | 20 | 50 | 20 | 50 |
| H₂[mL/min(normal)] | 580 | 1100 | — | — | — | — |
| B₂H₆[ppm(with respect to SiH₄)] | — | — | 0→200 | 200→ | 200 | 200→600 |
| | | | | 600→ | | |
| | | | | 200 | | |
| N₂[mL/min(normal)] | — | — | 300 | 300→ | 300 | 300→600 |
| | | | | 600→ | | |
| | | | | 300 | | |
| CH₄[mL/min(normal)] | 500 | — | — | — | — | — |
| NO[% or ppm(with respect to | 2% | — | — | — | 0→ | — |
| SiH₄)] | | | | | 8 ppm→0 | |
| SiF₄[mL/min(normal)] | 270 | 260 | — | — | 5 | — |
| Support temperature [° C.] | 75 | 78 | 260 | 260 | 260 | 260 |
| Pressure[Pa] | 150 | 500 | 52 | 50 | 52 | 50 |
| RF power[W] | 2 | 30 | 180 | 200 | 180 | 200 |
| Thickness[μm] | 2.5 | 30 | 0.1 | 0.2 | 0.1 | 0.6 |

TABLE 36

| | | | | | Electric | | light- | | |
|---|---|---|---|---|---|---|---|---|---|
| Photosensitive | | | Residual | | potential | Optical | transmitting | | Image |
| member | Resolution | Chargeability | potential | Sensitivity | unevenness | memory | property | CLN | defect |
| Example 16 | A | A | A | A | B | A | A | A | C |

As is apparent from the above results, properties except a reduction in image defects were improved when the Group 13 element content and the nitrogen atom content in the surface region layer had peaks at an identical phase.

### EXAMPLE 17

Deposition films were sequentially superimposed under the conditions shown in Table 37 in the same manner as in Example 8 except that the flow rate of an N₂ gas to be introduced into a lower injection-blocking layer was changed from that of Example 8, to thereby produce a photosensitive member composed of a lower injection-blocking layer, a photoconductive layer, and a surface region layer (a TBL-1, an intermediate layer, a TBL-2, and a surface protective layer). The produced photosensitive member was subjected to SIMS measurement. The local maximum values of the boron atom content were 6.4×10¹⁸ atoms/cm³ and 6.4×10¹⁸ atoms/cm³ from the photoconductive layer side. The interval between the local maximum values of the boron atom content was 700 nm, and the interval between the local maximum value and minimum value of the nitrogen atom content was 350 nm. In addition, the local maximum value of the nitrogen atom content represented by NI(Si+N) was 62 atm %.

The produced photosensitive member was evaluated for properties in the same manner as in Example 8. Table 38 shows the results.

TABLE 37

| | | | Surface region layer | | | |
|---|---|---|---|---|---|---|
| | Lower | | | | | Surface |
| | injection- | Photoconductive | | Intermediate | | protective |
| Kind and flow rate of gas | blocking layer | layer | TBL-1 | layer | TBL-2 | layer |
| SiH₄[mL/min(normal)] | 150 | 200 | 10 | 30 | 10 | 30 |
| H₂[mL/min(normal)] | 580 | 1200 | — | — | — | — |
| B₂H₆[ppm(with respect to SiH₄)] | — | — | 0→800→0 | — | 0→800→0 | — |
| N₂[mL/min(normal)] | 400 | — | 0→300 | 300→ | 300 | 300→500 |
| | | | | 500→ | | |
| | | | | 300 | | |
| CH₄[mL/min(normal)] | — | — | — | — | — | — |
| NO[% or ppm(with respect to | 2% | — | — | 0→ | — | — |
| SiH₄)] | | | | 8 ppm→0 | | |
| SiF₄[mL/min(normal)] | 270 | 260 | — | 220 | — | — |
| Support temperature [° C.] | 75 | 78 | 260 | 260 | 260 | 260 |
| Pressure[Pa] | 150 | 500 | 52 | 50 | 52 | 50 |
| RF power[W] | 2 | 30 | 250 | 300 | 250 | 300 |
| Thickness[μm] | 2.5 | 30 | 0.1 | 0.6 | 0.1 | 0.6 |

TABLE 38

| | | | | | Electric | | light- | | |
|---|---|---|---|---|---|---|---|---|---|
| Photosensitive | | | Residual | | potential | Optical | transmitting | | Image |
| member | Resolution | Chargeability | potential | Sensitivity | unevenness | memory | property | CLN | defect |
| Example 17 | A | A | A | A | B | A | A | A | B |

As is apparent from the above results, in all the items, the evaluated properties were improved when nitrogen atoms were introduced into the lower injection-blocking layer.

### EXAMPLE 18

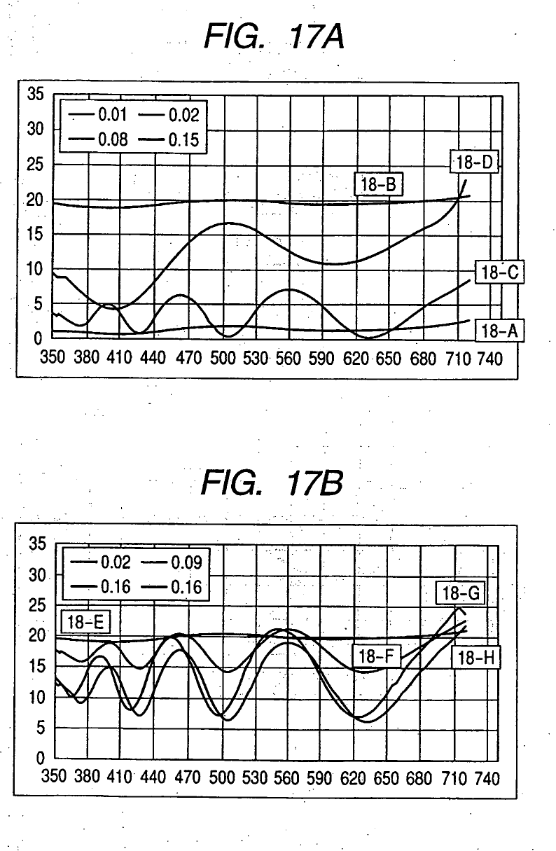

A gradient-composition layer was introduced as a first layer in a surface region layer. Photosensitive members (18-A to 18-H) each composed of a lower injection-blocking layer, a photoconductive layer, and a surface region layer (a TBL-1, an intermediate layer, a TBL-2, and a surface protective layer) were produced under the conditions shown in Table 39 in the same manner as in Example 8 except that the flow rate of each of an SiH₄ gas, a B_{2H}₆ gas, and an N₂ gas was changed in the deposition of the gradient-composition layer in such a manner that the photoconductive layer and the first upper injection-blocking layer would be optically continuous. The produced photosensitive members each were subjected to SIMS measurement. As a result, it was found that the nitrogen atom content and the boron atom content had peaks shown in FIG. 16A. The local maximum values of the boron atom content were 1.6×10¹⁹ atoms/cm³ and 4.0×10¹⁸ atoms/cm³ from the photoconductive layer side. The interval between the local maximum values of the boron atom content was 810 nm, and the interval between the local maximum value and minimum value of the nitrogen atom content was 350 nm. The local maximum value of the nitrogen atom content represented by N/(Si+N) was 65 atm %. The spectral reflection spectra of the produced photosensitive drums were measured by means of an MCPD-2000 manufactured by Otsuka Electronics Co., Ltd. FIG. 17A shows the spectral reflection spectra of the photosensitive members 18-A to 18-D. FIG. 17B shows the spectral reflection spectra of the photosensitive members 18-E to 18-H. In each of the photosensitive members 18-A to 1-D, the minimum value (Min) and maximum value (Max) of a reflectivity (%) in the wavelength range of 350 nm to 680 nm satisfied the relationship of 0%≦Max(%)≦20% and the relationship of 0≦(Max−Min)/(100−Max)≦0.15. In each of the photosensitive members 18-E to 18-H, the minimum value (Min) and maximum value (Max) of a reflectivity (%) in the wavelength range of 350 nm to 680 nm did not satisfy the above relationships. It should be noted that the numerical values described in FIGS. 17A and 17B are each a value of (Max−Min)/(100−Max).

Each of the produced photosensitive members was evaluated for photoelectric properties in the same manner as in Example 8. Table 40 shows the results.

TABLE 39

| | | | Surface region layer | | | | |
|---|---|---|---|---|---|---|---|
| | Lower | | Gradient- | | | | Surface |
| | injection- | Photoconductive | composition | | Intermediate | | protective |
| Kind and flow rate of gas | blocking layer | layer | layer | TBL-1 | layer | TBL-2 | layer |
| SiH₄[mL/min(normal)] | 250 | 200 | 200→20 | 20 | 30 | 20 | 30 |
| H₂[mL/min(normal)] | 750 | 1200 | — | — | — | — | — |
| B₂H₆[ppm(with respect to SiH₄)] | — | — | 0→ | 200 | — | 800 | — |
| | | | 2000→20 | | | | |
| N₂[mL/min(normal)] | — | — | 0→600 | 600 | 700 | 600 | 700 |
| CH₄[mL/min(normal)] | 500 | — | 2 | — | — | — | — |
| NO[% or ppm(with respect to | 6% | — | 2 ppm | — | 6 ppm | — | — |
| SiH₄)] | | | | | | | |
| SiF₄[mL/min(normal)] | — | — | 3 | — | 2 | — | — |
| Support temperature [° C.] | 280 | 270 | 240 | 260 | 260 | 260 | 260 |
| Pressure[Pa] | 85 | 72 | 58 | 52 | 50 | 52 | 50 |
| RF power[W] | 300 | 450 | 200 | 250 | 300 | 250 | 300 |
| Thickness[μm] | 3 | 35 | 0.12 | 0.1 | 0.6 | 0.1 | 0.6 |

TABLE 40

| | | | | | Electric | | light- | | |
|---|---|---|---|---|---|---|---|---|---|
| Photosensitive | | | Residual | | potential | Optical | transmitting | | Image |
| member | Resolution | Chargeability | potential | Sensitivity | unevenness | memory | property | CLN | defect |
| Example 18-A | A | A | A | A | A | A | A | A | A |
| Example 18-B | A | A | A | A | A | A | A | A | A |
| Example 18-C | A | A | A | A | A | A | A | A | A |
| Example 18-D | A | A | A | A | A | A | A | A | A |
| Example 18-E | A | A | A | A | C | A | A | A | A |
| Example 18-F | A | A | A | A | C | A | A | A | A |
| Example 18-G | A | A | A | A | C | A | A | A | A |
| Example 18-H | A | A | A | A | C | A | A | A | A |

As is apparent from the above results, with each of the photosensitive members in which layers ranging from a photoconductive layer to a upper injection-blocking layer were optically continuous; and the minimum value (Min) and maximum value (Max) of a reflectivity (%) in the wavelength range of 350 nm to 680 nm satisfied the above relationships, electric potential unevenness, in particular, exposure unevenness out of all kinds of electric potential unevenness was alleviated. In each of the photosensitive members of Examples 1 to 18, the minimum value (Min) and maximum value (Max) of a reflectivity (%) in the wavelength range of 350 nm to 680 nm satisfied the above relationships.

The present application claims priority from Japanese Patent Application Nos. 2004-358099 filed on Dec. 10, 2004 and 2004-358131 filed on Dec. 10, 2004, which are hereby incorporated by reference herein.

What is claimed is:

1. An electrophotographic photosensitive member comprising:
a conductive substrate;
a photoconductive layer composed of a non-single-crystal silicon film using at least a silicon atom as a base material, the photoconductive layer being superimposed on the conductive substrate; and
a surface region layer composed of a non-single-crystal silicon nitride film which uses a silicon atom and a nitrogen atom as base materials and at least part of which contains a Group 13 element in the periodic table, the surface region layer being superimposed on the photoconductive layer,
wherein a content of the Group 13 element with respect to a total amount of constituent atoms has a distribution having at least two local maximum values in a thickness direction of the surface region layer.

2. An electrophotographic photosensitive member according to claim 1, wherein an average concentration (N/(Si+ON)) (atm %) of nitrogen atoms of the surface region layer satisfies a relationship of 30 atm %≦N/(Si+N)≦70 atm %.

3. An electrophotographic photosensitive member according to claim 1, wherein a distance between two adjacent local maximum values of the Group 13 element content with respect to the total amount of the constituent atoms is in a range of 100 nm to 1,000 nm in the thickness direction of the surface region layer.

4. An electrophotographic photosensitive member according to claim 1, wherein a local maximum value closest to the photoconductive layer out of the local maximum values of the Group 13 element content with respect to the total amount of the constituent atoms in the surface region layer is highest.

5. An electrophotographic photosensitive member according to claim 1, wherein in the surface region layer, a local maximum value closest to the photoconductive layer of the Group 13 element content is 5.0×10¹⁸ atoms/cm³ or more, or a minimum value of the Group 13 element content between two adjacent local maximum values is 2.5×10¹⁸ atoms/cm³ or less.

6. An electrophotographic photosensitive member according to claim 1, wherein a minimum value (Min) and a maximum value (Max) of a reflectivity (%) in a wavelength range of 350 nm to 680 nm satisfy a relationship of 0%≦Max(%)≦20% and a relationship of 0≦(Max−Min)/(100−Max)≦0.15.

7. An electrophotographic photosensitive member according to claim 1, wherein a content of oxygen atoms and/or fluorine atoms in the surface region layer with respect to the total amount of the constituent atoms has at least one local maximum value in the thickness direction of the surface region layer.

8. An electrophotographic photosensitive member according to claim 1, wherein a nitrogen atom content with respect to the total number of the constituent atoms has distribution with at least two local maximum values in the thickness direction of the surface region layer.

9. An electrophotographic photosensitive member according,to claim 8, wherein the surface region layer has atomic distribution in which a local maximum value of the nitrogen atom content with respect to the total number of the constituent atoms in the thickness direction and a local maximum value of the Group 13 element content with respect to the total number of the constituent atoms in the thickness direction are present alternately.

10. An electrophotographic photosensitive member according to claim 1, wherein the surface region layer has atomic distribution in which a local maximum value of the Group 13 element content with respect to the total number of the constituent atoms in the thickness direction and a local maximum value of the nitrogen atom content with respect to the total number of the constituent atoms in the thickness direction are present in this order from the photoconductive layer toward a free surface side.

11. An electrophotographic photosensitive member according to claim 8, wherein in the surface region layer, a distance between a local maximum value on the photoconductive layer side out of the two adjacent local maximum values of the nitrogen atom content with respect to the total number of the constituent atoms in the thickness direction and a minimum value present between the two local maximum values is 40 nm or more to 300 nm or less.

12. An electrophotographic photosensitive member according to claim 8, wherein the local maximum values of the nitrogen atom content in the thickness direction in the surface region layer are 30 atom % or more, and each are 110% or more of the minimum value.

13. An electrophotographic photosensitive member comprising:
a conductive substrate;
a photoconductive layer composed of a non-single-crystal silicon film using at least a silicon atom as a base material, the photoconductive layer being superimposed on the conductive substrate; and
a surface region layer composed of a non-single-crystal silicon nitride film which uses a silicon atom and a nitrogen atom as base materials and at least part of which contains a Group 13 element in the periodic table, the surface region layer being superimposed on the photoconductive layer, the surface region layer having a gradient-composition layer in which a composition ratio between silicon atoms and nitrogen atoms is changed and a surface layer in which a composition ratio between silicon atoms and nitrogen atoms is constant,
wherein a content of the Group 13 element with respect to a total amount of constituent atoms has distribution with at least one local maximum value in a thickness direction of the gradient-composition layer and has distribution with at least one local maximum value in the thickness direction of the surface layer.

14. An electrophotographic photosensitive member according to claim 13, wherein an average concentration (N/(Si+N)) (atm %) of nitrogen atoms of the surface region layer satisfies a relationship of 30 atm %≦N/(Si+N)≦70 atm %.

15. An electrophotographic photosensitive member according to claim 13, wherein a distance between two adjacent local maximum values of the Group 13 element content with respect to the total amount of the constituent atoms is in a range of 100 nm to 1,000 nm in the thickness direction of the surface region layer.

16. An electrophotographic photosensitive member according to claim 13, wherein a local maximum value closest to the photoconductive layer out of the local maximum values of the Group 13 element content with respect to the total amount of the constituent atoms in the surface region layer is highest.

17. An electrophotographic photosensitive member according to claim 13, wherein in the surface region layer, a local maximum value closest to the photoconductive layer of the Group 13 element content is 5.0×10¹⁸ atoms/cm³ or more, or a minimum value of the Group 13 element content between two adjacent local maximum values is 2.5×10¹⁸ atoms/cm³ or less.

18. An electrophotographic photosensitive member according to claim 13, wherein a minimum value (Min) and a maximum value (Max) of a reflectivity (%) in a wavelength range of 350 nm to 680 nm satisfy a relationship of 0%≦Max(%)≦20% and a relationship of 0≦(Max−Min)/(100−Max)≦0.15.

19. An electrophotographic photosensitive member according to claim 13, wherein a content of oxygen atoms and/or fluorine atoms in the surface region layer with respect to the total amount of the constituent atoms has at least one local maximum value in the thickness direction of the surface region layer.

20. An electrophotographic photosensitive member according to claim 13, wherein a nitrogen atom content with respect to the total number of the constituent atoms has distribution with at least two local maximum values in the thickness direction of the surface region layer.

21. An electrophotographic photosensitive member according to claim 20, wherein the surface region layer has atomic distribution in which a local maximum value of the nitrogen atom content with respect to the total number of the constituent atoms in the thickness direction and a local maximum value of the Group 13 element content with respect to the total number of the constituent atoms in the thickness direction are present alternately.

22. An electrophotographic photosensitive member according to claim 13, wherein the surface region layer has atomic distribution in which a local maximum value of the Group 13 element content with respect to the total number of the constituent atoms in the thickness direction and a local maximum value of the nitrogen atom content with respect to the total number of the constituent atoms in the thickness direction are present in this order from the photoconductive layer toward a free surface side.

23. An electrophotographic photosensitive member according to claim 20, wherein in the surface region layer, a distance between a local maximum value on the photoconductive layer side out of the two adjacent local maximum values of the nitrogen atom content with respect to the total number of the constituent atoms in the thickness direction and a minimum value present between the two local maximum values is 40 nm or more to 300 nm or less.

24. An electrophotographic photosensitive member according to claim 13, wherein the local maximum values of the nitrogen atom content in the thickness direction in the surface region layer are 30 atom % or more, and each are 110% or more of the minimum value.
